(19) United States
(12) Patent Application Publication
(10) Pub. No.: US 2023/0300667 A1
(43) Pub. Date: Sep. 21, 2023

(54) COMMUNICATION METHOD AND DEVICE FOR XR SERVICE IN WIRELESS COMMUNICATION SYSTEM

(71) Applicant: Samsung Electronics Co., Ltd., Gyeonggi-do (KR)

(72) Inventors: Youngkyo BAEK, Gyeonggi-do (KR); Jicheol LEE, Gyeonggi-do (KR)

(21) Appl. No.: 18/102,290

(22) Filed: Jan. 27, 2023

(30) Foreign Application Priority Data
Jan. 27, 2022 (KR) 10-2022-0012743
Dec. 22, 2022 (KR) 10-2022-0182110

(51) Int. Cl. H04W 28/02

(52) U.S. Cl. CPC H04W 28/0268; H04L 67/131

(57) ABSTRACT

The disclosure relates to a communication method and device for an extended reality (XR) service in a wireless communication system. A method performed by an application server for the XR service in the wireless communication system includes allocating, to at least one UE, identification information for identifying the at least one UE using a same XR service or identifying at least one service flow for transferring XR data to each of the at least one UE and providing XR service-related information including the identification information and information about a delay time allowable for the XR service to the wireless communication system accessed by the at least one UE.

### CROSS-REFERENCE TO RELATED APPLICATION(S)

This application is based on and claims priority under 35 U.S.C. §119 to Korean Patent Application Nos. 10-2022-0012743 and 10-2022-0182110, which were filed on Jan. 27, 2022, and Dec. 22, 2022, respectively, in the Korean Intellectual Property Office, the entire disclosure of each which is incorporated herein by reference.

### BACKGROUND

### 1. Field

The disclosure relates generally to a communication method and device for an extended reality (XR) service in a wireless communication system.

### 2. Description of Related Art

Fifth generation (5G) mobile communication technology defines a wide frequency band to enable fast transmission speed and new services and may be implemented in frequencies below 6 GHz (sub 6 GHz), such as 3.5 GHz, as well as in ultra-high frequency bands (above 6 GHz), such as 28 GHz and 39 GHz called millimeter wave (mmWave). Further, sixth generation (6G) mobile communication technology, which is called a beyond 5G system, is considered to be implemented in terahertz bands (e.g., 95 GHz to 3 THz) to achieve a transmission speed 50 times faster than 5G mobile communication technology and ultra-low latency reduced by ⅒.

In the early stage of 5G mobile communication technology, standardization was conducted on beamforming and massive multiple-input and multiple-output (MIMO) for mitigating propagation pathloss and increasing propagation distance in ultrahigh frequency bands, support for various numerologies for efficient use of ultrahigh frequency resources (e.g., operation of multiple subcarrier gaps), dynamic operation of slot format, initial access technology for supporting multi-beam transmission and broadband, definition and operation of bandwidth part (BWP), new channel coding, such as low density parity check (LDPC) code for massive data transmission and polar code for high-reliable transmission of control information, L2 pre-processing, and network slicing for providing a dedicated network specified for a specific service, so as to meet performance requirements and support services for enhanced mobile broadband (eMBB), ultra-reliable low-latency communications (URLLC), and massive machine-type communications (mMTC).

Currently, improvement and performance enhancement in the initial 5G mobile communication technology is being discussed considering the services that 5G mobile communication technology has intended to support, and physical layer standardization is underway for technology, such as vehicle-to-everything (V2X) for increasing user convenience and assisting autonomous vehicles in driving decisions based on the position and state information transmitted from the voice over new radio (VoNR), new radio unlicensed (NR-U) aiming at the system operation matching various regulatory requirements, NR user equipment (UE) power saving, non-terrestrial network (NTN) which is direct communication between UE and satellite to secure coverage in areas where communications with a terrestrial network is impossible, and positioning technology.

Also being standardized are radio interface architecture/protocols for technology of industrial Internet of things (IIoT) for supporting new services through association and fusion with other industries, integrated access and backhaul (IAB) for providing nodes for extending the network service area by supporting an access link with the radio backhaul link, mobility enhancement including conditional handover and dual active protocol stack (DAPS) handover, 2-step random access channel (RACH) for NR to simplify the random access process, as well as system architecture/service fields for 5G baseline architecture (e.g., service based architecture or service based interface) for combining network functions virtualization (NFV) and software-defined networking (SDN) technology and mobile edge computing (MEC) for receiving services based on the position of the UE.

As 5G mobile communication systems are commercialized, a soaring number of connected devices that would be connected to communication networks so that reinforcement of the function and performance of the 5G mobile communication system and integrated operation of connected devices are expected to be needed. To that end, new research is to be conducted on, e.g., extended reality (XR) for efficiently supporting, e.g., augmented reality (AR), virtual reality (VR), and mixed reality (MR), and 5G performance enhancement and complexity reduction using artificial intelligence (AI) and machine learning (ML), support for AI services, support for metaverse services, and drone communications.

Further, development of such 5G mobile communication systems may be a basis for multi-antenna transmission technology, such as new waveform for ensuring coverage in 6G mobile communication terahertz bands, full dimensional MIMO (FD-MIMO), array antenna, and large scale antenna, full duplex technology for enhancing the system network and frequency efficiency of 6G mobile communication technology as well as reconfigurable intelligent surface (RIS), high-dimensional space multiplexing using orbital angular momentum (OAM), metamaterial-based lens and antennas to enhance the coverage of terahertz band signals, AI-based communication technology for realizing system optimization by embedding end-to-end AI supporting function and using satellite and AI from the step of design, and next-generation distributed computing technology for implementing services with complexity beyond the limit of the UE operation capability by way of ultrahigh performance communication and computing resources.

### SUMMARY

The disclosure has been made to address at least the above-mentioned problems and/or disadvantages and to provide at least the advantages described below.

The disclosure provides a method and device for transferring XR data to at least one UE using an XR service in a wireless communication system.

The disclosure provides a method and device for transferring XR data within an allowable delay time to at least one UE using a same XR service in a wireless communication system.

The disclosure provides a method and device for identifying at least one UE or at least one service flow (SF) for the same XR service in a wireless communication system.

The disclosure provides a method and device for providing quality of service (QoS) information and policy information for at least one service flow for the same XR service in a wireless communication system.

An aspect of the disclosure provides a method performed by an application server (AS) for an XR service in a wireless communication system, the method including allocating, to at least one UE, identification information for identifying the at least one UE using a same XR service or for identifying at least one service flow for transferring XR data to each of the at least one UE; and providing XR service-related information including the identification information and information about a delay time allowable for the XR service to the wireless communication system accessed by the at least two UEs.

Another aspect of the disclosure provides an AS for an XR service in a wireless communication system, the AS including a transceiver and a processor configured to allocate, to at least one UE, identification information for identifying the at least one UE using a same XR service or identifying at least one service flow for transferring XR data to each of the at least one UE; and provide XR service-related information including the identification information and information about a delay time allowable for the XR service to the wireless communication system accessed by the at least one UE through the transceiver.

Another aspect of the disclosure provides a method performed by a policy control function (PCF) configured to manage policy information for an XR service in a wireless communication system, the method including receiving, from an AS configured to provide XR service through a network exposure function (NEF), a first message including identification information for identifying at least one UE using a same XR service or identifying at least one service flow for transferring XR data to each of the at least one UE and first XR service-related information including QoS information related to at least one service flow based on the identification information, and transmitting a second message including second XR service-related information, which is based on the first XR service-related information, and the identification information to a session management function (SMF) configured to manage a protocol data unit (PDU) session related to the XR service.

A further aspect of the disclosure provides, a PCF configured to manage policy information in a wireless communication system, the PCF including a transceiver and a processor configured to receive, through the transceiver from an AS providing the XR service through an NEF, a first message including identification information for identifying at least one UE using a same XR service or identifying at least one service flow for transferring XR data to each of the at least one UE and first XR service-related information including QoS information related to at least one service flow based on the identification information; and transmit, through the transceiver, a second message including second XR service-related information, which is based on the first XR service-related information, and the identification information to an SMF configured to manage a PDU session related to the XR service.

### BRIEF DESCRIPTION OF THE DRAWINGS

The above and other aspects, features, and advantages of certain embodiments will be more apparent from the following description taken in conjunction with the accompanying drawings, in which:

FIG. 1A illustrates a transmission path of XR data in a wireless communication system according to an embodiment;

FIG. 1B illustrates a transmission path of XR data in a wireless communication system according to an embodiment;

FIG. 2 illustrates a method for identifying XR data for an XR service in a wireless communication system according to an embodiment;

FIG. 3 is a flowchart illustrating a method for transferring XR data for an XR service in a wireless communication system according to an embodiment;

FIGS. 4A and 4B illustrate a method for transferring XR data for an XR service in a wireless communication system according to an embodiment;

FIGS. 5A and 5B illustrate another method for transferring XR data for an XR service in a wireless communication system according to an embodiment;

FIG. 6 is a flowchart illustrating a method for changing an SMF for an XR service of a UE(s) requiring multi-modality support upon performing a PDU session establishment procedure by a UE in a wireless communication system according to an embodiment;

FIGS. 7A and 7B illustrate a method for transferring XR data for an XR service in a wireless communication system according to an embodiment;

FIGS. 8A and 8B illustrate a method for forming a group of UEs (or service flows) for multi-modality support for an XR service in a wireless communication system and applying QoS information for multi-modality to the corresponding group to a 5G system according to an embodiment;

FIG. 9 is a flowchart illustrating a method for transferring XR data for an XR service in a wireless communication system according to an embodiment; and

FIG. 10 illustrates a configuration of a network entity in a wireless communication system according to an embodiment.

### DETAILED DESCRIPTION

Hereinafter, the operational principle of the disclosure is described below with reference to the accompanying drawings. To avoid making the subject matter of the disclosure unclear, certain details of the known functions or configurations may be omitted.

Advantages and features of the disclosure, and methods for achieving the same may be understood through the embodiments to be described below taken in conjunction with the accompanying drawings. However, the disclosure is not limited to the embodiments disclosed herein, and various changes may be made thereto. The same reference numeral denotes the same element.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Each block may represent a module, segment, or part of a code including one or more executable instructions for executing a specified logical function(s). In some replacement execution examples, the functions mentioned in the blocks may occur in different orders. For example, two blocks that are consecutively shown may be performed substantially simultaneously or in a reverse order depending on corresponding functions.

As used herein, the term unit means a software element or a hardware element that plays a certain role. However, the term unit is not limited as meaning a software or hardware element. A unit may be configured in a storage medium that may be addressed or may be configured to reproduce one or more processors. Accordingly, as an example, a unit includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. A function provided in an element or a unit may be combined with additional elements or may be split into sub elements or sub units. Further, an element or a unit may be implemented to reproduce one or more central processing units (CPUs) in a device or a security multimedia card. In certain embodiments, a unit may include one or more processors.

UE may refer to a terminal, mobile station (MS), cellular phone, smartphone, computer, or various electronic devices capable of performing communication functions.

The embodiments of the disclosure may also apply to other communication systems with similar technical background or channel form. Further, embodiments of the disclosure may be modified in such a range as not to significantly depart from the scope of the disclosure under the determination by one of ordinary skill in the art and such modifications may be applicable to other communication systems.

In a specific description of the disclosure, a communication system may use various wired or wireless communication systems, e.g., the new RAN, which is the radio access network, and the packet core (5G system, or 5G core network, or next generation core (NG core)), which is the core network, according to the 5G communication standard of the 3GPP which is a radio communication standardization organization. Embodiments of the disclosure may also be applicable to communication systems with a similar technical background with minor changes without significantly departing from the scope of the disclosure, and this may be possible under the determination of those skilled in the art to which the disclosure pertains.

As used herein, terms for identifying access nodes, terms denoting network entities (NEs), terms denoting messages, terms denoting interfaces between network functions (NFs), and terms denoting various pieces of identification information are provided as an example for ease of description. Thus, the disclosure is not limited by the terms, and such terms may be replaced with other terms denoting objects with equivalent technical concept.

The 5G system may support the network slice, and traffic for different network slices may be processed by different PDU sessions. The PDU session may mean an association between a data network providing a PDU connection service and a UE. The network slice may be understood as technology for logically configuring a network with a set of NFs to support various services with different characteristics, such as broadband communication services, massive IoT, V2X, or other mission critical services, and separating different network slices. Therefore, even when a communication failure occurs in one network slice, communication in other network slices is not affected, so that it is possible to provide a stable communication service. The term slice may be used interchangeably with network slice. In such a network environment, the UE may access a plurality of network slices when receiving various services. Further, the NF may be a software instance running on hardware and be implemented as a virtualized function instantiated on a network element or an appropriate platform.

The mobile communication provider may constitute the network slice and may allocate network resources suitable for a specific service for each network slice or for each set of network slices. A network resource may mean an NF or logical resource provided by the NF or radio resource allocation of a base station.

For example, a mobile communication provider may configure network slice A for providing a mobile broadband service, network slice B for providing a vehicle communication service, and network slice C for providing an XR service as described below. In other words, the 5G network may efficiently provide a corresponding service to a UE through a specialized network slice suited for the characteristics of each service. In the 5G system, the network slice may be represented as single-network slice selection assistance information (S-NSSAI). The S-NSSAI may include a slice/service type (SST) value and a slice differentiator (SD) value. The SST may indicate the characteristics of the service supported by the network slice (e.g., eMBB, IoT, URLLC, V2X, XR service etc.). The SD may be a value used as an additional identifier for a specific service referred to as SST.

Examples of services requiring services (high data rate low latency (HDRLL) characterized by high data rate and low latency may include XR services, AR services, VR services, or cloud gaming services. The VR service is a service that provides a virtual environment implemented by a computer device by means of a VR headset or the like. The AR service is a service capable of combining a virtual environment with the real world based on location, geographical information, and the like. The XR service is a service that may not only combine a real environment and a virtual environment but also provide information, such as tactile, auditory, and olfactory senses, to the user, thereby increasing the user’s sense of experience.

In particular, the XR/AR/VR service may use one or a plurality of devices to provide the service. For example, when providing audio, video, and haptic services to the user, the device providing audio, the device providing video, and the device providing haptics, which implement a sense of touch by applying vibration and motion, may differ from each other. In this case, the XR/AR/VR data arriving at each device through the network is required to be transferred to the user within a time appropriate for the service to provide an XR/AR/VR service with high user experience. As such, the service to transfer different types of XR data to the user within a delay time appropriate for the XR service upon providing XR/AR/VR services (hereinafter, collectively referred to as XR service for convenience of description) is referred to as a multi-modality service. The term multi-modality service is used for convenience, and other various terms may be used to denote transfer of one or more XR data to the user within a delay time appropriate for the XR service.

Although the multi-modality service is described based on the XR service for convenience of description in the embodiments of the disclosure, the disclosure may also apply to various data services requiring multiple devices to be harmonized to provide a service to one user, as well as the XR service. Thus, it should be noted that the embodiments of the disclosure are not limited to the XR service.

As such, depending on service scenarios, the XR device(s) for XR service each may directly access the 5G network to provide the service or the XR devices may connect to one UE to access the 5G network through, e.g., tethering, to provide the service.

When various types XR service data, such as audio, video, or haptics, are transferred to the UE(s) used by the same user, the XR service data may be transmitted to the UE(s) at similar times to be transferred to the user within an allowable delay time, enhancing the user’s service experience.

For scheduling considering the delay time while transferring various types of XR data to the UE(s) for use of the same XR service, QoS and policy information may be defined, and related QoS and policy information may be transferred to the NG-RAN and the user plane function (UPF) to seamlessly provide a multi-modality service.

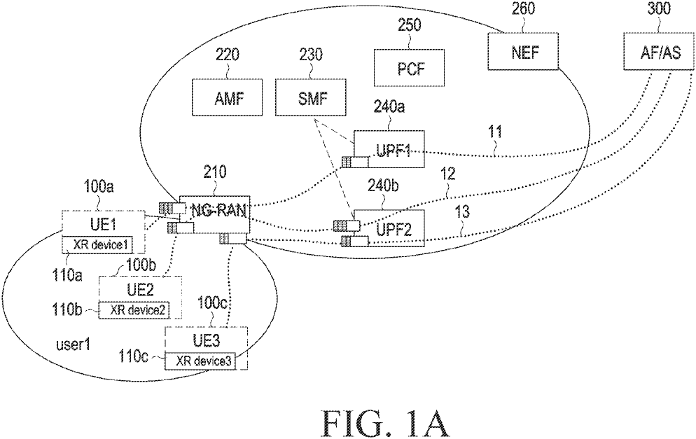

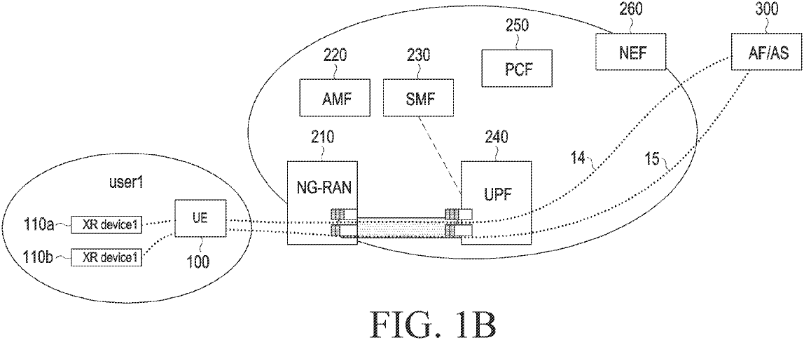

FIG. 1A illustrates a transmission path of XR data in a wireless communication system according to an embodiment.

In FIG. 1A, transmission paths 11, 12, and 13 are shown through which XR data according to an XR service is transferred from the application function (AF)/AS 300 through one or more UPFs 240a and 240b and next generation-radio access network (NG-RAN) 210 to a plurality of UEs 100a, 100b, and 100c used by one user (user 1). The plurality of UEs 100a, 100b, and 100c may operate as XR devices 110a, 110b, and 110c that receive different types of XR data, such as audio data, video data, and haptic data.

FIG. 1B illustrates a transmission path of XR data in a wireless communication system according to an embodiment.

FIG. 1B illustrates, for example, transmission paths 14 and 15 through which XR data according to an XR service is transferred from the AF/AS 300 through the UPF 240 and the NG-RAN 210 to a plurality of XR devices 110a and 110b connected with one UE 100 used by one user user!. Each of the plurality of XR devices 110a and 110b may receive different types of XR data, such as audio data, video data, or haptic data. The AF/AS 300 may be, e.g., an AS of an external network providing an XR service.

The network technology may refer to the standards (e.g., TS 23.501, TS 23.502, TS 23.503, etc.) defined by the international telecommunication union (ITU) or 3GPP, and each of the components included in the network architecture of FIGS. 1A and 1B may mean a physical entity or may mean software that performs an individual function or hardware combined with software. Reference characters denoted by Nx in the drawings, such as N1, N2, N3,..., etc., indicate known interfaces between NFs in the 5G core network (CN), and the relevant descriptions may be found in the standard specifications (TS 23.501). Therefore, a detailed description will be omitted.

The wireless communication system shown in FIGS. 1A and 1B may include a radio access network (NG-RAN) and a 5G core network (5GC). The NG-RAN 210 may be a base station (e.g., gNB or IAB) supporting radio access technology in the 5G system. The NG-RAN 210 may provide XR service-related information and/or data, transferred from the AF/AS 300 of the external network through the core network (i.e., 5GC), to the UEs 100a, 100b, and 100c including the XR devices 110a, 110b, and 110c or the UE 100 connected with the XR devices 110a, 110b, and 110c. Further, the NG-RAN 210 may provide the AF/AS 300 with the XR service-related information and/or data received from the UE(s) 100 (100a, 100b, and 100c). As in FIG. 1B, the UE (or XR device) may perform communication with the AF/AS 300 using technology using a sidelink, such as proximity service for direct communication with another UE (or XR device) connected with the NG-RAN 210 without direct connection with the NG-RAN 210, or non-3GPP radio access technology, such as Wi-Fi or Bluetooth™. In the following embodiments, the UE may be understood as a UE that is wirelessly or wiredly connected with one or more XR devices, as in FIG. 1B, or performs communication via the 5G system between the XR device and the AS/AF as the UE(s) includes one or more XR devices, as in FIG. 1A.

In FIGS. 1A and 1B, the 5GC may include network entities, such as an access and mobility management function (AMF) 220, an SMF 230, a UPF 240, a PCF 250, or a unified data management (UDM).

The AMF 220 is an entity for managing access and mobility of the UE. The AMF 220 may serve as a UE-core network endpoint through which the UE connects with other entity(s) of the 5GC through the NG-RAN. As an example, the AMF 220 may perform network functions such as registration of the UE, connection, reachability, mobility management, access identification, authentication, and mobility event generation.

The SMF 230 may perform a management function for a PDU session of the UE. For example, the SMF 230 may perform network functions such as session management functions of establishing, modifying, or releasing a session and maintaining a tunnel between the UPF 240 and the NG-RAN 210 necessary for functions of allocating and managing an Internet protocol (IP) address of the terminal, selection and control of the user plane, control of traffic processing on the UPF, and billing data gathering control.

The UPF 240 may serve to process the UE’s user data (e.g., XR data) and may play a role to process XR data to transfer the XR data generated by the UE to the AF/AS 300 or transfer the data introduced from the AF/AS 300 to the UE. The UPF 240 may perform network functions, such as acting as an anchor between radio access technologies (RATs), providing connection with PDU sessions and the AF/AS 300, packet routing and forwarding, packet inspection, application of user plane policy, creating a traffic usage report, or buffering.

The UDM performs functions that include, e.g., generating authentication information for 3GPP security, processing the user ID, managing a list of NFs supporting the UE, and managing subscription information. The unified data repository (UDR) may perform functions of storing and providing subscription information managed by the UDM, structured data for exposure, and application data related to an NEF 260 or service.

The PCF 250 is an NF that manages operator policy information for providing a service in the 5G system. The UDR may store subscription information for the UE and may provide the UDM with the subscription information. The UDR may store operator policy information and may provide operator policy information to the PCF. The NEF 260 may be responsible for transmitting or receiving an event occurring in the 5G system and a supported capability to/from the outside. For example, the NEF 260 may perform functions that include, e.g., safe supply of information about of the AF/AS 300 to the 5GC, conversion of internal/external information, and storing in the UDR and then redistributing the information received from other NFs.

The UE may access the NG-RAN 210 for registration in the 5G system. For example, the UE may access the NG-RAN 210 to perform a UE registration procedure with the AMF 220. During the registration procedure, the AMF 220 may determine a network slice available to the UE accessing the NG-RAN 210 and allocate the network slice to the UE. The UE may select a network slice and establish a PDU session for communication with the AF/AS 300. One PDU session may include one or more QoS flows, and each QoS flow may set different parameters to provide a different transmission performance required for each application service.

In the communication system of the example of FIGS. 1A and 1B, since the XR data received by each XR device should be transferred to each XR device within a delay time allowable to provide the XR service, the time taken for the XR data to be transferred from the AF/AS through the 5G system or transferred to the UE including or connected to the XR device should fall within the allowable range. For example, when the user of the XR device touches an object in the virtual space, the heard sound, touch, and image should be transferred to the UE within the allowable delay time and be transferred to the XR device wiredly/wirelessly connected with the UE or included in the UE to enable a multi-modality service according to an embodiment.

To that end, according to certain embodiments, a scheme is provided in which the network with QoS and policy transmits XR data to enable a service for enhancing the user experience for an XR service, i.e., a multi-modality service, by controlling the time taken for the XR data for providing the XR service to the user to be transferred to each XR device through the 5G system to fall within an allowable delay time.

Although embodiments of the disclosure are described in light of the downlink to receive XR data by at least one UE, the schemes disclosed herein may be applicable in an identical/similar manner to the uplink to transmit XR data by at least one UE.

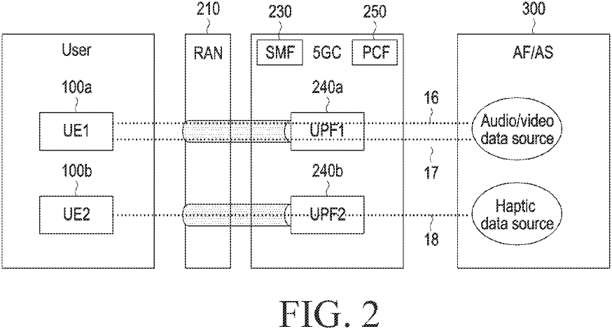

FIG. 2 illustrates a method for identifying XR data for an XR service in a wireless communication system according to an embodiment. Identifying the XR data includes distinguishing or defining the XR data, and is collectively referred to as identifying herein.

Referring to FIG. 2, assumed is an example in which a same user uses two UEs 100a and 100b that are connected with, or include, an XR device for an XR service, and the UE 100a receives audio and video data 16 and 17 as first XR data through a transmission path which passes from the AF/AS 300 through UPF1 240a. The UE 100b receives haptic data 18 as second XR data through a transmission path which passes through UPF2 240b. The first and second XR data are data for providing the same XR service. Information, referred to herein as AF specific SF group ID, is provided for identifying at least one of a group of XR data for providing the same XR service (e.g., the first and second XR data), a group of service flows related to the XR service, or a group of UEs (or XR devices) receiving the XR service. QoS information and/or policy information is provided for the XR service applied to the service flow(s) for transmission of the first and second XR data. Also, various procedures are provided for providing the XR service by signaling the proposed information between the AF/AS and the 5G system or between the network entities of the 5G system. In the 5GC of FIG. 2, the SMF 230 may perform session management for maintaining the tunnel between UPF1 and UPF2 240a and 240b and the NG-RAN 210 for transferring the first and second XR data, and the PCF 250 may provide QoS information and/or policy information related to transmission of the first and second XR data.

As information for identifying the XR data, for example, at least one of the XR application ID for providing the XR service or the XR AF ID of the AF/AS, the user ID indicating the user to be served by the UE on the application for the XR service, or the AF specific SF group ID indicating the group of the UEs (or XR devices) receiving the XR service and/or the group of the service flows related to the XR service may be used. For convenience, the information is referred to as an AF specific service flow (SF) group ID.

As the UE ID indicating the UE, the user identifier (i.e., subscription permanent identifier (SUPI)) used in the 5G system or the UE’s IP address, or the generic public subscription identifier (GPSI) allocated to the UE or AF specific GPSI is required, and at least one of the PDU session ID of the PDU session for transferring the XR data in the 5G system and the XR-dedicated QoS flow identification (QFI) for identifying the QoS flow related to the XR service may be used in the embodiments of the disclosure. Herein, the XR service may be assumed to be allocated separate QoS flows to support high data rate (eMBB), ultra low-latency (URLLC) services.

In addition to the information (e.g., AF specific SF group ID) for identifying the XR data related to the same XR service, an application data unit (ADU) identifier or an ADU sequence number may be used to indicate the unit of XR data at the application level or media level.

In describing the various embodiments, unless mentioned otherwise, the XR application ID, XR AF ID, application ID, and AF ID may be used to indicate the application, application service, or AF related to the XR service. Unless mentioned otherwise, the user ID and the AF specific SF group ID may be used to identify the UEs used by the user or the same XR service. In other words, in the embodiments, the AF specific SF group ID may be used to identify the group of XR service flows related to the same XR service (or group of a plurality of XR data) or to identify one or more UEs (or XR devices) related to the same XR service. The UE ID, SUPI, GPSI, AF specific GPSI, and UE IP address, which are used to indicate the UE, may be used for the same purpose unless mentioned otherwise.

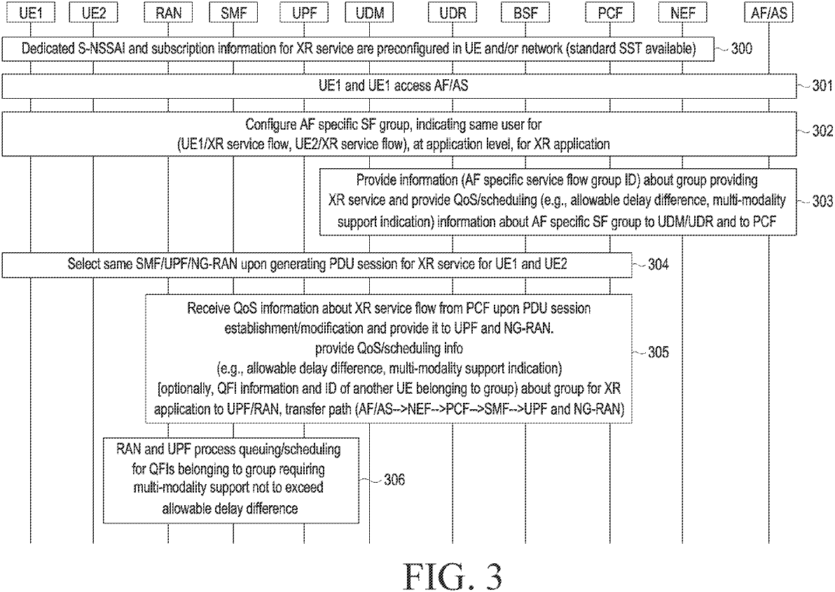

Various methods for transferring at least one XR data for an XR service to at least one UE (or at least one XR device) of the same user within an allowable delay time are described below with reference to FIGS. 3 to 9. As such, when at least one XR data for the same XR service is received within an allowable delay time, the user’s experience for the XR service may be enhanced, so that the XR service may be stably provided. To that end, an SMF may be selected (or relocated) so that at least one XR service flow for transferring at least one XR data is processed through the same SMF, and QoS information and/or policy information for the at least one XR service flow may be provided from the AF/AS through the PCF and SMF to the UPF and NG-RAN (also referred to as RAN herein) which transfers the at least one XR data. The QoS information and/or policy information may include allowable delay difference information indicating the allowable delay time. As the information for identifying the at least one XR service flow (or at least one XR data) for the same XR service, the AF specific SF group ID may be used as described above. For a basic description of the network entities (SMF, PCF, NEF, etc.) operating in the embodiments of FIGS. 3 to 9, the foregoing description made in connection with FIGS. 1A and 1B may be referenced. For a basic description of messages transmitted/received between network entities in the embodiments of FIGS. 3 to 9, 3GPP NR standards (e.g., TS 23.501, TS 23.502, TS 23.503, etc.) may be referenced. Although FIGS. 3 to 8 illustrate two UEs, i.e., UE1 and UE2, as the plurality of UEs using an XR service according to various embodiments, one UE, or two or more UEs may use the same XR service.

FIG. 3 is a flowchart illustrating a method for transferring XR data for an XR service in a wireless communication system according to an embodiment. FIG. 3 illustrates a procedure in which a plurality of XR data for the same XR service is transferred from the AF/AS to the plurality of UEs of the user within an allowable delay time.

FIG. 3 considers use of an XR service through UE1 and UE2 which are the same user’s UEs. In FIG. 3, UE1 and UE2 each may include an XR device or may be UEs connected with an XR device. The example provided in FIG. 3 may be applied in the same manner even when a plurality of XR devices are connected to one UE, as in FIG. 1B.

For an XR service, in step 300 of FIG. 3, basic settings may be made between UE1 and UE2 and the 5G system to use the XR service. For example, it is assumed that an XR-dedicated S-NSSAI which is the identifier of the dedicated network slice for the XR service is configured in the UE and/or network. In this case, the XR-dedicated S-NSSAI may include an SST for XR service or an SST for XR service provided by the communication carrier. Additionally, the XR-dedicated S-NSSAI may include an SD for identifying a specific XR service or a specific XR service application.

The subscription information about the UEs (e.g., UE1 and UE2) set in step 300 may include the XR-dedicated S-NSSAI corresponding to the XR service, which may be received by the UE through the network, or may include the AF/AS ID, which is the ID of the AF/AS providing the XR service to the UE or application ID and or the AF specific GPSI or GPSI which is an ID for defining the UE by the AF/AS. When a group of UEs (or XR devices) that are to together receive the XR service is predetermined, the AF specific SF group ID for defining the group or user ID or pairing information may be included in the subscription information. As such, when the subscription information includes the AF specific SF group ID, the procedure for configuring the AF specific SF group between the AF/AS and the UE (e.g., UE1 or UE2) and the procedure for providing the 5G system with the AF specific SF group ID, which is information indicating the configured group, or user ID or pairing information may be omitted and, as necessary, the information configured in step 300 may be updated by the network.

In step 301 of FIG. 3, UE1 and UE2 for receiving the XR service may access the AF/AS providing the XR service and, in this case, UE1 and UE2 may access the AF/AS through the 5G system or Wi-Fi. Various communication schemes may be used for UE1 and UE2 to access the AF/AS.

In step 302 of FIG. 3, to identify the UE1 and the UE2 that are using the same XR service, the AF/AS may allocate/configure the same AF specific SF group ID to UE1 and UE2 through signaling with UE1 and UE2. The AF specific SF group ID may be allocated to the group of the UEs receiving the same XR service, and be used to identify the group of the UEs or may also identify the group of XR service flows (SFs) for providing XR data related to the same XR service to the group of the UEs. Further, the pairing information between the UEs receiving the same XR service or the email account of the user of the UEs or the user ID managed by the application for the XR service may be used instead of the AF specific SF group ID. For convenience, embodiments of using the AF specific SF group ID are described. However, the disclosure is not limited as using the AF specific SF group ID to identify the group of UEs receiving the same XR service and/or the group of related XR SFs.

In step 303 of FIG. 3, the AF/AS may provide the 5G system with at least one (hereinafter the XR service-related information) among the policy information, scheduling information, and XR service-related QoS information to be applied to the XR service flows identified by the AF specific SF group ID. The information provided from the AF/AS may be stored in the UDM or in the UDR through the UDM. The information stored in the UDR may be transferred to the PCF to be used to perform XR service-related QoS and/or scheduling for the corresponding XR service flows in the 5G system. The XR service-related information may include a multi-modality support indication indicating whether to support a multi-modality service for the UE(s) corresponding to the AF specific SF group ID or the XR service flows for the UE(s). Upon supporting the multi-modality service, the XR service-related information may include an allowable delay difference between delay times caused while transferring/processing XR data of each XR service flow to the UE(s). The UE ID, e.g., the SUPI or GPSI or AF specific GPSI or UE IP address, may be included in the XR service-related information to identify the UE(s) corresponding to (belonging to) the AF specific SF group ID while providing the XR service-related information and the AF specific SF group ID from the AF/AS to the 5G system. The XR service-related information may be provided from the 5G system to the corresponding UEs (UE1 and UE2).

The XR service-related information may be provided to the NEF of the 5G system by the AF/AS and be transferred from the NEF to the PCF. The XR service-related information transferred from the AF/AS may include a plurality of parameters for QoS and scheduling, and all or some of the plurality of parameters may be allowed and applied, as they are, in the 5G system or be changed and applied. Therefore, when at least some of the parameters of the first XR service-related information transferred from the AF/AS to the NEF are changed in the 5G system, the second XR service-related information transferred from the PCF to the SMF, UPF, and NG-RAN may be applied in the UPF and the NG-RAN. As such, the XR service-related information transferred from the AF/AS to the NEF and the XR service-related information transferred from the PCF to the SMF, UPF, and NG-RAN may be divided, and are collectively referred to herein as XR service-related information.

The information, i.e., XR service flow detection information, for detecting an XR service flow(s) by the UPF and the SMF may include at least one of the AF/AS ID, the source ID address and port information about the AF/AS, the sequence number (SN), or the ID of the ADU which is application level packet information. The XR service flow detection information may be transferred from the AF/AS to the PCF through the NEF and be transfer to the UPF via the PCF and the SMF.

Meanwhile, if UE1 and UE2 have accessed the 5G system before by being reset before performing step 340 of FIG. 3 and after performing step 302 of FIG. 3, UE1 and UE2 may perform a procedure of deregistering from the 5G system and then registering again in the 5G system. The reset and re-registration of UE1 and UE2 may be intended for providing a stable XR service by UE1 and UE2 and be optionally performed. Although resetting UE1 and UE2 and performing registration again, information for the XR service, such as the AF specific GPSI or GPSI allocated to the UE may remain in the 5G network and the UE.

Thereafter, in step 304 of FIG. 3, the corresponding UEs (UE1 and UE2) belonging to the same AF specific SF group ID may perform a procedure for establishing a PDU session to receive the XR service and, during the course, the operation in which the same SMF is selected for the same AF specific SF group ID and additional same UPF and same NG-RAN are selected so that a multi-modality service may be provided when processing each XR service flow may be performed. The operation in which the same UPF and/or the same NG-RAN is selected may be optionally performed.

The SMF selected in step 304 of FIG. 3 applies the QoS based on the XR service-related information while the UPF and NG-RAN process data packets for the respective XR service flows of the corresponding UEs UE1 and UE2. To minimize the difference between the delay times taken to XR service flows, respectively, the XR data may be transferred to the UEs UE1 and UE2 within the allowable delay difference, so that XR data may be served to the user at a similar time. Further, to enhance the user’s experience of the XR service, an XR dedicated QFI for each XR service flow may be allocated, and the UPF and the NG-RAN may allocate a separate queue for the XR dedicated QFI and allow for it to be possible to adjust the difference between the delay times taken for scheduling the XR dedicated QFI for each XR service flow therebetween, so that the difference between the delay times when the XR data is transferred to the UEs UE1 and UE2 falls within the allowable delay difference.

Thereafter, in step 305 of FIG. 3, forwarding information and the XR service-related information for the XR service and the XR service flow detection information transferred to the PCF in step 303 may be transferred from the PCF to the SMF through a PDU session establishment or PDU session modification process. The SMF, receiving the XR service-related information, may allocate an XR dedicated QFI to each XR service flow and transfer the XR service flow detection information and XR service-related information for XR service and/or forwarding information, for each XR dedicated QFI, to the UPF and the NG-RAN. The forwarding information is information used while transferring (forwarding) the data of the XR service flow from the UPF to the NG-RAN.

In this case, an indicator indicating that it is needed to allocate a dedicated queue to the XR dedicated QFI may be included in the information transferred to the UPF and NG-RAN, meeting the delay time for each XR data. Thus, it is possible to smoothly measure and manage the difference in delay time for each XR data in the 5G system. The UPF and NG-RAN, receiving the indicator indicting that allocation of a dedicated queue to the XR dedicated QFI is needed, may allocate a dedicated queue to the corresponding QFI. The indicator indicating that allocation of a dedicated queue to the XR dedicated QFI is needed may be omitted from the transferred information if information about the XR dedicated QFI is preconfigured by the UPF.

In step 306 of FIG. 3, the NG-RAN and the UPF may allocate a dedicated queue to the XR dedicated QFIs based on the information transferred from the SMF and process so that the queueing and scheduling delay time difference does not exceed the allowable delay difference for the UEs corresponding to the AF specific SF group or the UEs′ XR service flows (or XR specific QFIs).

Meanwhile, although the aspect in which the UE(s) processes downlink data while receiving an XR service is described in connection with each embodiment, it is also possible to meet the allowable delay difference and QoS requirements in the same manner as processing downlink data by including information for processing uplink data in the forwarding data and the XR service-related information for the XR service.

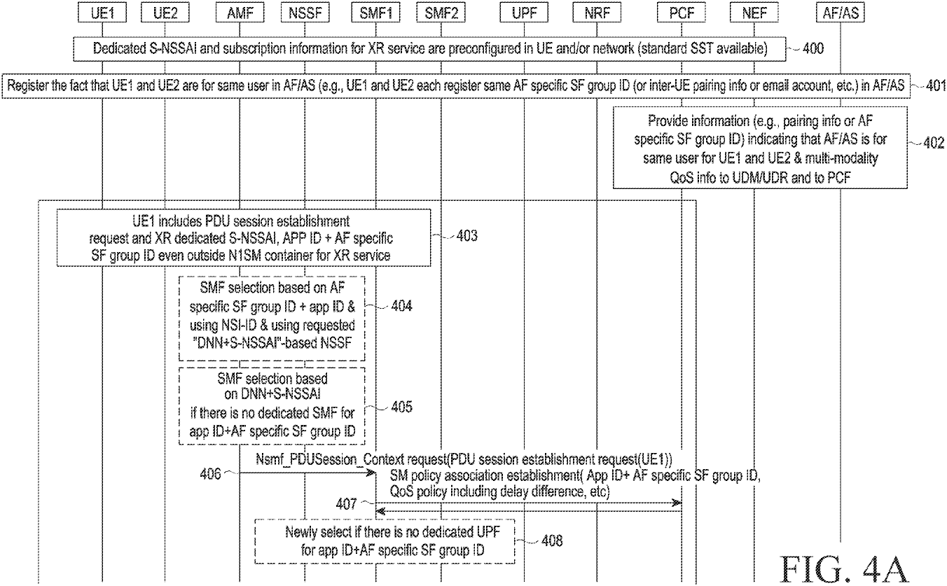

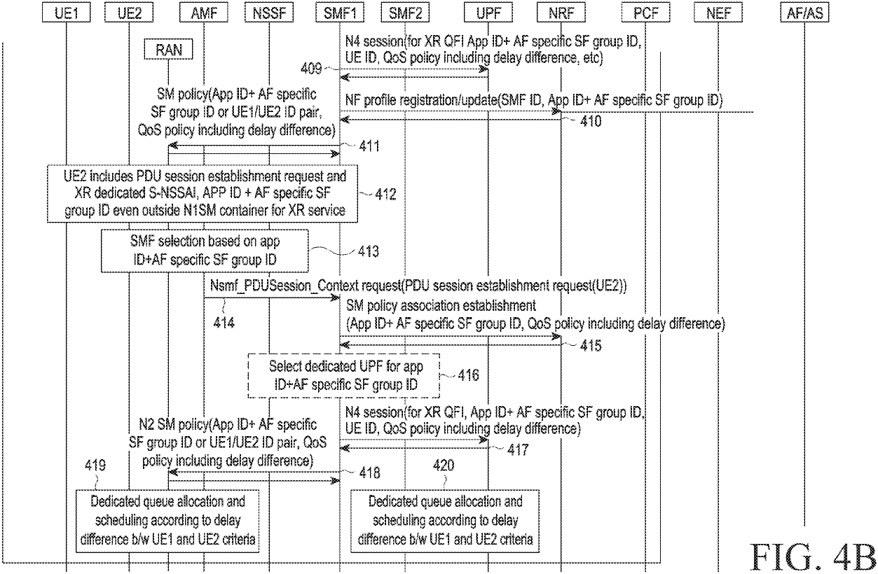

FIGS. 4A and 4B illustrate a method for transferring XR data for an XR service in a wireless communication system according to an embodiment. Specifically, FIGS. 4A and 4B illustrate selection of an SMF for an XR service in steps 303 to 306 and transfer of XR service-related information from the AF/AS through the PCF to the UPF and NG-RAN to apply QoS for multi-modality service. In FIGS. 4A and 4B, UE1 and UE2, used by the same user, each may include an XR device or may be UEs connected with an XR device. The example of FIGS. 4A and 4B may be applied in the same manner even when a plurality of XR devices are connected to one UE, as in FIG. 1B.

The method of FIGS. 4A and 4B is directed to a scheme in which when UE1 and UE2 perform a PDU session establishment procedure for an XR service, the same SMF is selected for UE1 and UE2, and the SMF selects the same UPF for the XR service. As such, when the same SMF is selected for a plurality of XR service flows, it is possible to select the same UPF and the same NG-RAN for the plurality of XR service flows or it is also possible to select different UPFs and different NG-RANs.

Further, the method of FIGS. 4A and 4B regards a scheme for smoothly providing a multi-modality service by transferring XR service-related information for the multi-modality service to the UPF and NG-RAN, for QoS flows for an XR service of UE1 and UE2 through the selected SMF. As a method for selecting the same SMF, an SMF is selected based on the information received by the AMF from UE1, and information about the selected SMF is stored in the network repository function (NRF) which manages registration information about the NFs in the 5G system, and then, the stored SMF may be selected for other UEs (e.g., UE2) that gains access later.

For an XR service, in step 400 of FIG. 4A, basic settings may be made between UE1 and UE2 and the 5G system to use the XR service. For example, it is assumed that an XR-dedicated S-NSSAI for the XR service is configured in the UEs UE1 and UE2 and/or network. In this case, the XR-dedicated S-NSSAI may include an SST for XR service as described above, or an SST for XR service provided by the communication carrier. Additionally, the XR dedicated S-NSSAI may include an SD for identifying a specific XR service or a specific XR service application.

The subscription information about UE1 and UE2 set in step 400 of FIG. 4A may include the XR dedicated S-NSSAI corresponding to the XR service that may be received through the network by UE1 and UE2 and may include the AF/AS ID which is the ID of the AF/AS providing the XR service to be received by UE1 and UE2, the AF specific GPSI or GPSI which is the ID for defining UE1 and UE2 by the AF/AS, the AF specific group ID or user ID for defining a group of UE1 and UE2 together providing the XR service to the user may be included in the subscription information.

In step 401 of FIG. 4A, UE1 and UE2 for receiving the XR service may access the AF/AS providing the XR service and, in this case, UE1 and UE2 may access the AF/AS through the 5G system or Wi-Fi. Various communication schemes may be used for UE1 and UE2 to access the AF/AS. To identify UE1 and UE2 using the same XR service, the AF/AS may allocate/configure the same AF specific SF group ID to UE1 and UE2 through signaling with UE1 and UE2. In this case, the AF specific SF group ID may be allocated to the group of the UEs receiving the same XR service, and be used to identify the group of the UEs or may also identify the group of XR SFs for providing XR data related to the same XR service to the group of the UEs. The pairing information between UE1 and UE2 receiving the same XR service or the email account of the user or the user ID managed by the application may be used instead of the AF specific SF group ID. For convenience of description, embodiments of using the AF specific SF group ID are described. However, the disclosure is not limited as using the AF specific SF group ID to identify the group of UEs receiving the same XR service and/or the group of related XR SFs.

In step 402 of FIG. 4A, the AF/AS may provide the 5G system with the above-described XR service-related information to be applied to the XR service flows identified by the AF specific SF group ID. The XR service-related information provided from the AF/AS may be stored in the UDM or in the UDR through the UDM. The XR service-related information stored in the UDR may be transferred to the PCF to be used to perform QoS and/or scheduling for multi-modality service for the corresponding XR service flows in the 5G system.

Meanwhile, if UE1 and UE2 have accessed the 5G system before by being reset before performing step 403 of FIG. 4A and after performing step 401 of FIG. 4A, UE1 and UE2 may perform a procedure of deregistering from the 5G system and then registering again in the 5G system. This procedure may be performed optionally.

In step 403 of FIG. 4A, UE1, which is to receive an XR service, may include the XR dedicated S-NSSAI and data network name (DNN) even outside the N1 session management (SM) non-access stratum (NAS) container according to the 3GPP standard, along with the PDU session establishment request message in the process of performing the procedure of establishing a PDU session for an XR service. The N1 SM NAS container may include the PDU session establishment request message. The PDU session establishment request message may include the application ID or AF/AS ID which is information about the application providing the XR service and the AF specific SF group ID which is group information about the UEs used together in using the XR service obtained by UE1 in step 401 of FIG. 4A. The AF specific SF group ID may be included even outside the N1 SM NAS container. As such, the reason for additionally including the AF specific SF group ID in the field outside the N1 SM NAS container is that the AMF receiving the NAS message including the PDU session establishment request message may not identify information in the N1 SM NAS container.

UE1 may include the XR dedicated S-NSSAI, DNN, application ID and/or AF/AS ID, and AF specific SF group ID in the fields outside the N1 SM container transferred to the AMF through the PDU session establishment request message, notifying the AMF of the XR dedicated S-NSSAI and DNN, application ID or AF ID and AF specific SF group ID to be used for the PDU session requested to be established.

Therefore, in step 404 of FIG. 4A, the AMF receiving the NAS message (i.e., PDU session establishment request message) may send a request to the network slicing selection function (NSSF) and/or NRF based on the XR dedicated S-NSSAI and DNN and application ID or AF specific SF group ID received from UE1 or the network slice instance identifier (NSI ID) previously allocated, and select an SMF appropriate for the XR service of UE1. For example, the AMF may transfer information, such as the XR dedicated S-NSSAI and UE1′s tracking area identifier (TAI) information, to the NSSF and receive information about the NRF present in the network slice instance appropriate for the XR service of UE1 from the NSSF or receive the NSI ID and, based on the information received from the NSSF, transfer the XR dedicated S-NSSAI and DNN and application ID or AF specific SF group ID and NSI ID to the NRF, and in reply, receive an SMF instance appropriate for the XR service from the NRF and select it.

In step 405 of FIG. 4A, when there is no dedicated SMF instance for the application ID or AF specific SF group ID, the AMF may select an SMF based on the XR dedicated S-NSSAI and the DNN.

In step 406 of FIG. 4A, the AMF may transfer the PDU session establishment request message received from UE1 to the selected SMF and, in step 407, SMF1 receiving the PDU session establishment request message transmits an Npcf_SMPolicyControl_ Create request message including information, such as the application ID or AF ID, AF specific SF group ID, and AF specific GPSI, as well as the SUPI, DNN, S-NSSAI, and PDU session ID, to the PCF through an SM policy association establishment process. Thus, SMF1 sends a request for the XR service-related information to be applied to the AF specific SF group, which is information about the service flows and the UE to which the multi-modality service is to be applied in the XR service, to the PCF. The PCF identifies whether it has XR service-related information to be applied to UE1 and, if having the corresponding XR service-related information, provides it to SMF1. If the PCF does not have the corresponding XR service-related information, the PCF requests and receives, from the UDR, XR service-related information to be applied to the AF specific SF group used for the application ID or AF ID, and transfers the received XR service-related information to SMF1 through the Npcf_SMPolicyControl_Create response.

The XR service-related information may further include at least one of information indicating whether application of the dedicated QoS flow to the XR service flow is required, information indicating whether dedicated queuing is required, information indicating whether to apply a multi-modality service to the XR service flow, and a difference between delay times allowed when a multi-modality service is applied.

The PCF may transfer information for detecting XR service flow(s), i.e., the above-described XR service flow detection information, by the UPF and SMF, to SMF1. The XR service flow detection information may include, e.g., the AF ID or application ID or AS address information, i.e., IP address and port information, or application level packet information, i.e., the sequence number or ID of the ADU.

In step 408 of FIG. 4A, SMF1, which receives the XR service-related information and the XR service flow detection information, newly selects a UPF if no UPF is allocated for the DNN, S-NSSAI and application ID and AF specific SF group ID, detects the ID of the QoS flow to be applied to the PDU session requested to be established for UE1 in step 409 of FIG. 4B and transfers information to be applied to the corresponding QoS flow to the UPF through N4 session establishment or update. Therefore, the information transferred to the UPF may include, e.g., QFI for the XR service flow and information for detecting the same, e.g., AF ID or application ID or AF/AS address information, i.e., IP address and port information or application level packet information, i.e., ADU ID or SN. The information transferred to the UPF in step 409 of FIG. 4B may include the indicator indicating whether to apply a multi-modality service to the XR service flow and delay time difference allowed when the multi-modality service is applied.

Meanwhile, in step 410 of FIG. 4B, SMF1 may register the NF profile in the NRF or update it to select the SMF ID of SMF1 for the DNN, S-NSSAI, application ID or AF ID, AF specific SF group ID, to the NRF.

Thereafter, in step 411 of FIG. 4B, SMF1 may include, in the N2 SM message container to the NG-RAN, the QFI and AF ID or application ID and AF specific SF group ID and the UE IDs allocated to UE1 and UE2 belonging to the AF specific SF group, e.g., 5G globally unique temporary identifier (GUTI) or 5G-S-temporary mobile subscriber identity (TMSI) list, and information about the QFIs serving the XR service flow by the UEs UE1 and UE2, the indicator indicating whether dedicated queuing is required, the indicator indicating whether to apply a multi-modality service to the XR service flow, and the delay time difference allowed when the multi-modality service is applied, as SM policy information, and transfer it to the NG-RAN. Therefore, the above-described XR service-related information may be provided to the NG-RAN through the path of AF/AS → NEF → PCF → SMF → NG-RAN.

Meanwhile, a procedure in which another UE, i.e., UE2, for the XR service establishes a PDU session for the XR service may be performed in the same manner as the procedure for establishing a PDU session by UE1. However, in step 413 of FIG. 4B, the AMF may request information for SMF selection from the NSSF and/or NRF based on the DNN, S-NSSAI, application ID or AF ID, and AF specific SF group ID transferred through step 412 of FIG. 4B from UE2 in the process of selecting the SMF by the AMF and may select SMF1 registered through step 410 as an SMF appropriate for the XR service of UE2. For example, the AMF may select the NSI ID allocated to the network slice instance according to information, such as TAI information about UE2 and the XR dedicated S-NSSAI and request an SMF appropriate for the XR service of UE2 from the NRF based on the DNN, S-NSSAI, application ID or AF ID, AF specific SF group ID, and NSI ID, obtain address information or ID of SMF1 which is information about SMF1 which is the dedicated SMF in step 404 or registered in step 410 and select SMF1 for the XR service of UE2.

In step 414 of FIG. 4B, the AMF may transfer the PDU session establishment request message received from UE1 to the selected SMF and, in step 415 of FIG. 4B, SMF1 receiving the PDU session establishment request message transmits an Npcf_SMPolicyControl_Create request message including information, such as the application ID or AF ID, AF specific SF group ID, and AF specific GPSI, as well as the SUPI, DNN, S-NSSAI, and PDU session ID, to the PCF through an SM policy association establishment process. Thus, SMF1 sends a request for the XR service-related information to be applied to the AF specific SF group, which is information about the service flows and the UE to which the multi-modality service is to be applied in the XR service, to the PCF. The PCF identifies whether it has XR service-related information to be applied to UE2 and, if having the corresponding XR service-related information, provides it to SMF1 and, if not having the corresponding XR service-related information, requests and obtains, from the UDR, XR service-related information to be applied to the AF specific SF group used for the application ID or AF ID, and transfers the obtained XR service-related information to SMF1 through the Npcf_SMPolicyControl_ Create response.

The XR service-related information may further include at least one of information indicating whether application of the dedicated QoS flow to the XR service flow is required, information indicating whether dedicated queuing is required, information indicating whether to apply a multi-modality service to the XR service flow, and a difference between delay times allowed when a multi-modality service is applied.

The PCF may transfer information for detecting XR service flow(s), i.e., the above-described XR service flow detection information, by the UPF and SMF, to SMF1. The XR service flow detection information may include, e.g., the AF ID or application ID or AS address information, i.e., IP address and port information, or application level packet information, i.e., the sequence number or ID of the ADU.

In step 416 of FIG. 4B, SMF 1, receiving the XR service-related information and the XR service flow detection information, newly selects a UPF if no UPF is allocated for the DNN, S-NSSAI and application ID and AF specific SF group ID, detects the ID of the QoS flow to be applied to the PDU session requested to be established for UE2 in step 417 of FIG. 4B and transfers information to be applied to the corresponding QoS flow to the UPF through N4 session establishment or update. Therefore, the information transferred to the UPF may include, e.g., QFI for the XR service flow and information for detecting the same, e.g., AF ID or application ID or AF/AS address information, i.e., IP address and port information or application level packet information, i.e., ADU ID or SN. The information transferred to the UPF in step 417 of FIG. 4B may include the indicator indicating whether to apply a multi-modality service to the XR service flow and delay time difference allowed when the multi-modality service is applied.

Thereafter, in step 418 of FIG. 4B, SMF1 may include, in the N2 SM message container to the NG-RAN, the QFI and AF ID or application ID and AF specific SF group ID and the UE IDs allocated to UE1 and UE2 belonging to the AF specific SF group, e.g., 5G GUTI or 5G-S-TMSI list, and information about the QFIs serving the XR service flow by the UEs UE1 and UE2, the indicator indicating whether dedicated queuing is required, the indicator indicating whether to apply a multi-modality service to the XR service flow, and the delay time difference allowed when the multi-modality service is applied, as SM policy information, and transfer it to the NG-RAN. Therefore, the above-described XR service-related information may be provided to the NG-RAN through the path of AF/AS → NEF → PCF → SMF → NG-RAN.

Thereafter, in step 420 of FIG. 4B, the UPF allocates a dedicated queue to the dedicated QFI according to the N4 session message received by the UPF in steps 409 and 417, schedules UE1 and UE2 so that the delay time difference required to forward or schedule the data packets of the respective XR dedicated QFIs of UE1 and UE2 to UE1 and UE2 is smaller than an allowed delay time difference. Further, in step 419 of FIG. 4B, the NG-RAN allocates a dedicated queue to the dedicated QFI according to the N2 SM message received by the NG-RAN in steps 411 and 418, and schedules UE1 and UE2 so that the delay time difference required to forward or schedule the data packets of the respective XR dedicated QFIs of UE1 and UE2 is smaller than the allowed delay time difference. Accordingly, UE1 and UE2 receiving the XR data receive XR service data within the allowed delay time difference, smoothly supporting the multi-modality service to the user.

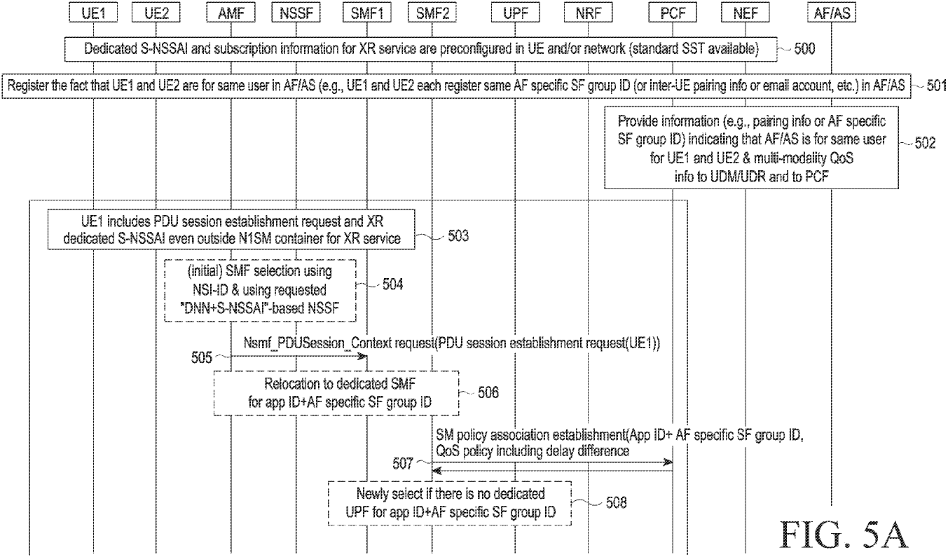

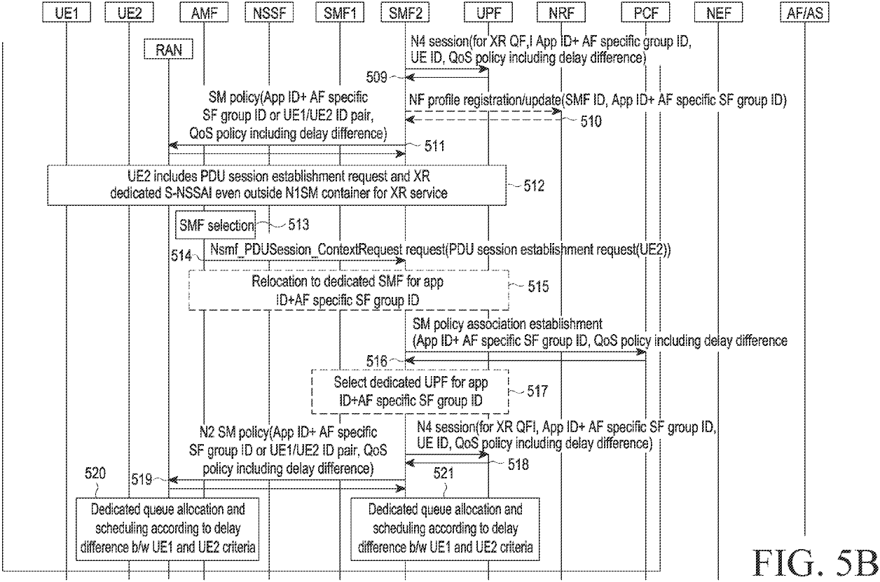

FIGS. 5A and 5B illustrate another method for transferring XR data for an XR service in a wireless communication system according to an embodiment. Specifically, FIGS. 5A and 5B illustrate another example of selection of an SMF for an XR service in steps 303 to 306 of FIG. 3 and transfer of XR service-related information from the AF/AS through the PCF to the UPF and NG-RAN to apply QoS for multi-modality service. In the method of FIGS. 5A and 5B, UE1 and UE2, used by the same user, each may include an XR device or may be UEs connected with an XR device. The method of FIGS. 5A and 5B may be applied in the same manner even when a plurality of XR devices are connected to one UE, as in FIG. 1B.

The method of FIGS. 5A and 5B is directed to a scheme in which when UE1 and UE2 perform a PDU session establishment procedure for an XR service, the same SMF is selected for UE1 and UE2, and the SMF selects the same UPF for the XR service. As such, when the same SMF is selected for a plurality of XR service flows, it is possible to select the same UPF and the same NG-RAN for the plurality of XR service flows or it is also possible to select different UPFs and different NG-RANs.

Further, the method of FIGS. 5A and 5B regards a scheme of relocating to an appropriate SMF or transferring the context of the SMF when it is difficult for the SMF to smoothly provide a multi-modality service when the AMF selects the SMF in the same SMF selection method, storing information about the selected SMF in the NRF, and selecting the stored SMF for other UEs that gain access later.

The configuration for use of an XR service, AF specific SF group ID configuration for an XR service of UE1 and UE2, and operations for providing abnormal sign-related information to the 5G system from the AF/AS in steps 500 to 502 of FIG. 5A are identical to the operations of steps 400 to 402 of FIG. 4A. For conciseness, the detailed description is not repeated here. A procedure in which UE1 and UE2 deregister from the 5G system and then register in the 5G system again may be optionally performed in the same manner after performing step 501 of FIG. 5A before performing step 503.

The configuration of the above-described XR service-related information and the XR service flow detection information is identical to that described in connection with FIGS. 4A and 4B. For conciseness, the detailed description is not repeated here.

In step 503 of FIG. 5A, UE1, which is to receive an XR service, may include the XR dedicated S-NSSAI and DNN even outside the N1 SM NAS container according to the 3GPP standard, along with the PDU session establishment request message in the process of performing the procedure of establishing a PDU session for an XR service. The N1 SM NAS container may include the PDU session establishment request message. Thus, the XR dedicated S-NSSAI and DNN to be used for the PDU session may be known to the AMF. Further, along with the PDU session establishment request message, the application ID or AF/AS ID which is information about the application providing the XR service and the AF specific SF group ID which is group information about the UEs used together in using the XR service obtained by UE1 in step 501 may be included even outside the N1 SM NAS container.

Therefore, in step 504 of FIG. 5A, the AMF receiving the NAS message may send a request to the NSSF and/or NRF based on the XR dedicated S-NSSAI and DNN ID received from UE1 or previously allocated NSI ID and select an initial SMF appropriate for the XR service of UE1. For example, the AMF may transfer information, such as the XR dedicated S-NSSAI and UE1′s TAI information, to the NSSF and receive information about the NRF present in the network slice instance appropriate for the XR service of UE1 from the NSSF or receive the NSI ID and, based on the information received from the NSSF, transfer the XR dedicated S-NSSAI and DNN and NSI ID to the NRF, and in reply, receive an SMF instance appropriate for the XR service from the NRF and select it.

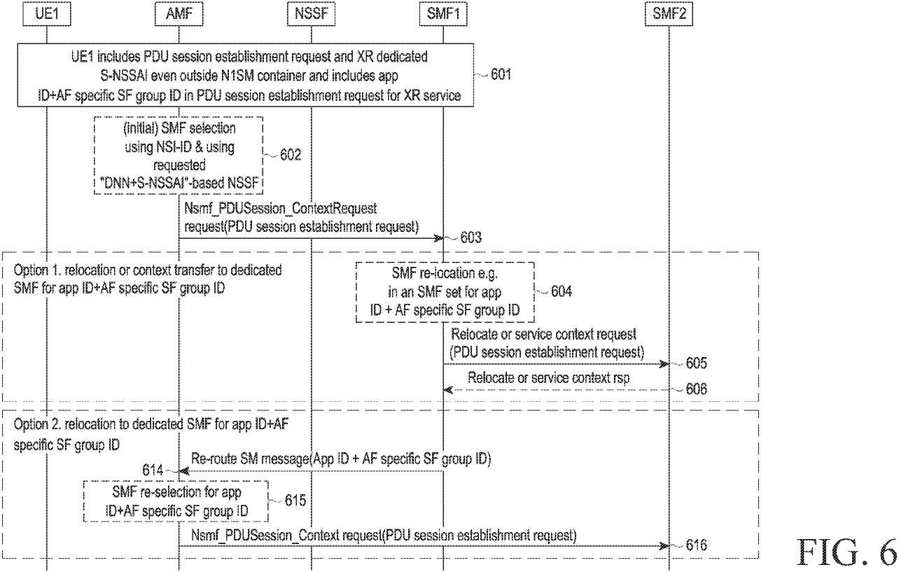

In step 505 of FIG. 5A, the AMF may transfer the PDU session establishment request message received from UE1 to selected SMF1 and, in step 506 of FIG. 5A, upon determining that an XR service and a multi-modality service for the AF specific SF group ID are impossible based on the application ID or AF ID and AF specific SF group ID included in the PDU session establishment request message, SMF1 receiving the PDU session establishment request message may perform SMF service context transfer or SMF relocation to another SMF instance which may serve the corresponding AF specific SF group ID. Here, a method for performing SMF service context transfer or SMF relocation is described below in connection with the embodiment of FIG. 6.

When SMF2 is selected as the SMF capable of serving the AF specific SF group ID through SMF relocation, SMF2 receiving the PDU session establishment request message transmits an Npcf_SMPolicyControl_Create request message including information, such as the application ID or AF ID, AF specific SF group ID, and AF specific GPSI, as well as the SUPI, DNN, S-NSSAI, and PDU session ID, to the PCF through an SM policy association establishment process in step 507 of FIG. 5A. Thus, SMF2 sends a request for the XR service-related information to be applied to the AF specific SF group, which is information about the service flows and the UE to which the multi-modality service is to be applied in the XR service, to the PCF. The PCF identifies whether it has XR service-related information to be applied to UE1 and, if having the corresponding XR service-related information, provides it to SMF2 and, if not having the corresponding XR service-related information, requests and receives, from the UDR, XR service-related information to be applied to the AF specific SF group used for the application ID or AF ID, and transfers the received XR service-related information to SMF1 through the Npcf_SMPolicyControl_ Create response. In step 508 of FIG. 5A, SMF2, receiving the XR service-related information and the XR service flow detection information, newly selects a UPF if no UPF is allocated for the DNN, S-NSSAI and application ID and AF specific SF group ID, detects the ID of the QoS flow to be applied to the PDU session requested to be established for UE1 in step 509 of FIG. 5B and transfers information to be applied to the corresponding QoS flow to the UPF through N4 session establishment or update. Therefore, the information transferred to the UPF may include, e.g., QFI for the XR service flow and information for detecting the same, e.g., AF ID or application ID or AF/AS address information, i.e., IP address and port information or application level packet information, i.e., ADU ID or SN. The information transferred to the UPF in step 509 of FIG. 5B may include the indicator indicating whether to apply a multi-modality service to the XR service flow and delay time difference allowed when the multi-modality service is applied.

Meanwhile, in step 510 of FIG. 5B, SMF2 may register the NF profile in the NRF or update it to select the SMF ID of SMF1 for the DNN, S-NSSAI, application ID or AF ID, AF specific SF group ID, to the NRF.

Thereafter, in step 511 of FIG. 5B, SMF2 may include, in the N2 SM message container to the NG-RAN, the QFI and AF ID or application ID and AF specific SF group ID and the UE IDs allocated to UE1 and UE2 belonging to the AF specific SF group, e.g., 5G GUTI or 5G-S-TMSI list, and information about the QFIs serving the XR service flow by the UEs UE1 and UE2, the indicator indicating whether dedicated queuing is required, the indicator indicating whether to apply a multi-modality service to the XR service flow, and the delay time difference allowed when the multi-modality service is applied, as SM policy information, and transfer it to the NG-RAN. Therefore, the above-described XR service-related information may be provided to the NG-RAN through the path of AF/AS → NEF → PCF → SMF → NG-RAN.

Meanwhile, in step 512 of FIG. 5B, a procedure in which another UE, UE2, for the XR service establishes a PDU session for the XR service may be performed in the same manner as the procedure for establishing a PDU session by UE1. However, in step 513 of FIG. 5B, the AMF may select an initial SMF for the XR service of UE2 by the same method as that of step 504 of FIG. 5A and, in step 515 of FIG. 5B, perform SMF service context transfer or SMF relocation to SMF2 serving the AF specific SF group ID based on the DNN, S-NSSAI, application ID or AF ID, and AF specific SF group ID transferred from UE2 through step 514 of FIG. 5B. A method for performing SMF service context transfer or SMF relocation is described below in connection with the embodiment of FIG. 6. In step 515 of FIG. 5B, SMF2 is selected as an SMF capable of serving the AF specific SF group ID through SMF relocation.

In step 516 of FIG. 5B, SMF2 receiving the PDU session establishment request message through step 514 transmits an Npcf_SMPolicyControl_Create request message including information, such as the application ID or AF ID, AF specific SF group ID, and AF specific GPSI, as well as the SUPI, DNN, S-NSSAI, and PDU session ID, to the PCF through an SM policy association establishment process. Thus, SMF2 sends a request for the XR service-related information to be applied to the AF specific SF group, which is information about the service flows and the UE to which the multi-modality service is to be applied in the XR service, to the PCF. The PCF identifies whether it has XR service-related information to be applied to UE2 and, if having the corresponding XR service-related information, provides it to SMF2 and, if not having the corresponding XR service-related information, requests and receives, from the UDR, XR service-related information to be applied to the AF specific SF group used for the application ID or AF ID, and transfers the received XR service-related information to SMF1 through the Npcf_SMPolicyControl_Create response.

In step 517 of FIG. 5B, SMF2, receiving the XR service-related information and the XR service flow detection information, newly selects a UPF if no UPF is allocated for the DNN, S-NSSAI and application ID and AF specific SF group ID, detects the ID of the QoS flow to be applied to the PDU session requested to be established for UE2 in step 518 and transfers information to be applied to the corresponding QoS flow to the UPF through N4 session establishment or update. Therefore, the information transferred to the UPF may include, e.g., QFI for the XR service flow and information for detecting the same, e.g., AF ID or application ID or AF/AS address information, i.e., IP address and port information or application level packet information, i.e., ADU ID or SN. Further, the information transferred to the UPF in step 509 of FIG. 5B may include the indicator indicating whether to apply a multi-modality service to the XR service flow and delay time difference allowed when the multi-modality service is applied.

Thereafter, in step 519 of FIG. 5B, SMF2 may include, in the N2 SM message container to the NG-RAN, the QFI and AF ID or application ID and AF specific SF group ID and the UE IDs allocated to UE1 and UE2 belonging to the AF specific SF group, e.g., 5G GUTI or 5G-S-TMSI list, and information about the QFIs serving the XR service flow by the UEs UE1 and UE2, the indicator indicating whether dedicated queuing is required, the indicator indicating whether to apply a multi-modality service to the XR service flow, and the delay time difference allowed when the multi-modality service is applied, as SM policy information, and transfer it to the NG-RAN. Therefore, the above-described XR service-related information may be provided to the NG-RAN through the path of AF/AS → NEF → PCF → SMF → NG-RAN.

Thereafter, in step 521 of FIG. 5B, the UPF allocates a dedicated queue to the dedicated QFI according to the N4 session message received by the UPF in steps 509 and 518, schedules UE1 and UE2 so that the delay time difference required to forward or schedule the data packets of the respective XR dedicated QFIs of UE1 and UE2 to UE1 and UE2 is smaller than an allowed delay time difference. In step 520 of FIG. 5B, the NG-RAN allocates a dedicated queue to the dedicated QFI according to the N2 SM message received by the NG-RAN in steps 511 and 519 and schedules UE1 and UE2 so that the delay time difference required to forward or schedule the data packets of the respective XR dedicated QFIs of UE1 and UE2 is smaller than the allowed delay time difference. Accordingly, UE1 and UE2 receiving the XR service data receive XR service data within the allowed delay time difference, smoothly supporting the multi-modality service to the user.

FIG. 6 illustrates a method for changing an SMF for an XR service of a UE(s) requiring multi-modality support upon performing a PDU session establishment procedure by a UE in a wireless communication system according to an embodiment. Although one UE UE1 is described in FIG. 6 for convenience of description, the example provided in FIG. 6 may also apply to a plurality of UEs.

FIG. 6 regards a method for changing an SMF for an XR service of a UE(s) requiring multi-modality support, belonging to an AF specific SF group, which may be performed in steps 506 and 515 of FIGS. 5A and 5B. The method proposed in steps 604 to 606 of FIG. 6 may be used as Option 1 in which an initial SMF directly selects an SMF appropriate for the XR service of UE1 and forwards it or the method proposed in steps 614 to 616, as Option 2 in which the AMF selects an SMF appropriate for the XR service of UE1 using information transferred to the AMF by the initial SMF.

In step 601 of FIG. 6, UE1, which is to receive an XR service, may include the XR dedicated S-NSSAI and DNN as well as the N1 SM NAS container, in the PDU session establishment request message (NAS message) in the process of performing the procedure of establishing a PDU session for an XR service. The PDU session establishment request message may include the application ID or AF ID which is information about the application providing the XR service and the AF specific SF group ID which is group information about the UEs used together in using the XR service obtained by UE1 in step 601. Thus, the XR dedicated S-NSSAI and DNN to be used for the PDU session may be known to the AMF.

Therefore, in step 602 of FIG. 6, the AMF receiving the NAS message may send a request to the NSSF and/or NRF based on the XR dedicated S-NSSAI and DNN ID received from UE1 or previously allocated NSI ID and select an initial SMF appropriate for the XR service of UE1. For example, the AMF may transfer information, such as the XR dedicated S-NSSAI and UE1′s TAI information, to the NSSF and receive information about the NRF present in the network slice instance appropriate for the XR service of UE1 from the NSSF or receive the NSI ID and, based on the information received from the NSSF, transfer the XR dedicated S-NSSAI and DNN and NSI ID to the NRF, and in reply, receive an SMF instance appropriate for the XR service from the NRF and select it.

In step 603 of FIG. 6, the AMF may transfer the PDU session establishment request message received from the UE to SMF1, which is the selected initial SMF. Upon determining that the XR service and multi-modality service for the AF specific SF group ID are impossible based on the application ID or AF ID and AF specific SF group ID included in the PDU session establishment request message, SMF1 may perform SMF service context transfer or SMF relocation to another SMF instance where the AF specific SF group ID may be served, using either the method of Option 1 or the method of Option 2.

As indicated above, Option 1 may be performed through steps 604 to 606 of FIG. 6. In step 604, SMF1 may select an SMF instance serving the application ID and the AF specific SF group ID of the same SMF set. Alternatively, SMF1 may transfer the XR dedicated S-NSSAI and DNN and application ID or AF specific SF group ID and NSI ID to the NRF and, in reply, receive and select SMF2 which is an SMF instance appropriate for the XR service of UE1. In step 605 of FIG. 6, SMF1 transmits an SMF relocation request or an SMF service context transfer request to SMF2. The request message of step 605 may include the PDU session establishment request message of UE1. In response, in step 606 of FIG. 6, SMF2 may transfer an SMF relocation response or an SMF service context transfer response to SMF1.

Meanwhile, as also indicated above, Option 2 may be performed through steps 614 to 616 of FIG. 6. In step 614, SMF1 may transfer the PDU session establishment request message, along with the re-route SM request message, the XR dedicated S-NSSAI and DNN, and application ID or AF specific SF group ID obtained from the PDU session establishment request of UE1, to the AMF. The AMF, receiving information and the request of step 614 from the SMF, may transfer the XR dedicated S-NSSAI and DNN and application ID or AF specific SF group ID and NSI ID to the NRF to receive and select SMF2 which is an SMF instance appropriate for the XR service of UE1. In step 616 of FIG. 6, the AMF may transfer the PDU session establishment request message of UE1 to SMF2 and perform SMF relocation.

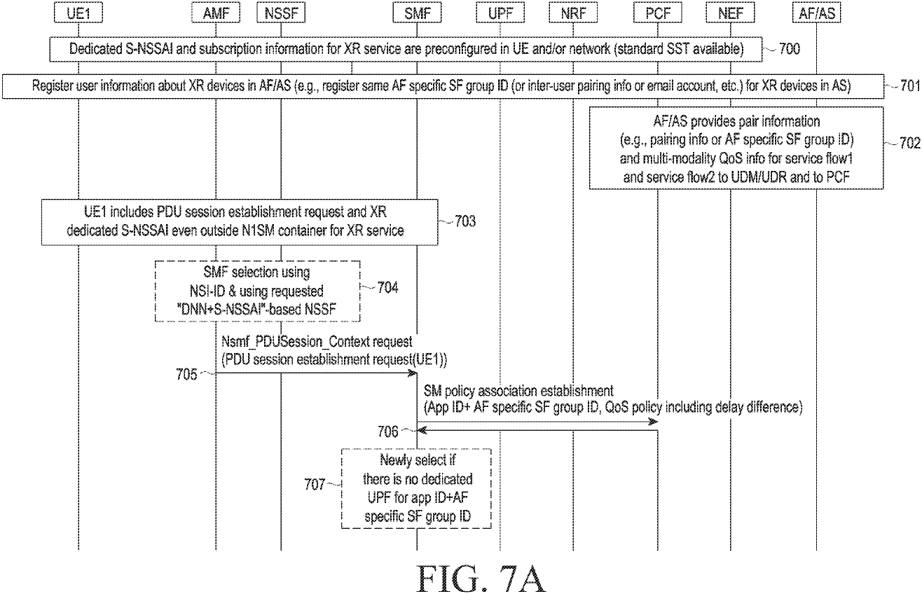

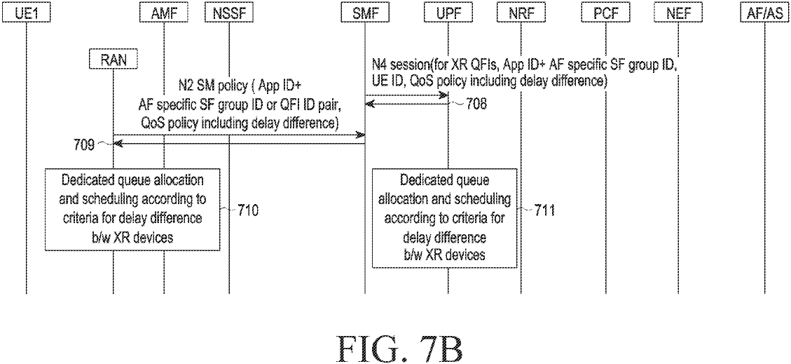

FIGS. 7A and 7B illustrate another method for transferring XR data for an XR service in a wireless communication system according to an embodiment. The method of FIGS. 7A and 7B regards a method for applying multi-modality QoS upon receiving an XR service through one UE UE1. Here, the UE UE1 may include a plurality of XR devices for use of an XR service or a plurality of XR devices may be wirelessly or wiredly connected.

Further, the method of FIGS. 7A and 7B smoothly provides a multi-modality service by transferring the above-described XR service-related information for the multi-modality service to the UPF and NG-RAN, for service flows for an XR service of one UE UE1.

In steps 700 to 702 of FIG. 7A, the configuration for use of an XR service, AF specific SF group ID configuration of an XR service, and operations for providing XR service-related information to the 5G system differ only in the context of providing an XR service to a plurality of XR devices included/connected to one UE UE1. Steps 400 to 402 of FIG. 4A may be applied to a plurality of service flows (service flow1 and service flow2) of one UE UE1 in the same manner. For conciseness, detailed descriptions of steps 700 to 702 is not repeated here. A procedure in which UE1 deregisters from the 5G system and then registers in the 5G system again may be optionally performed in the same manner after performing step 701 and before performing step 703 of FIG. 7A. The configuration of the above-described XR service-related information and the XR service flow detection information is identical to that described in connection with FIGS. 3, 4A and 4B. For conciseness, the detailed description is not repeated here.

Referring to FIG. 7A, in step 703, UE1, which is to receive an XR service, may include the XR dedicated S-NSSAI and DNN even outside the N1 SM NAS container according to the 3GPP standard, along with the PDU session establishment request message in the process of performing the procedure of establishing a PDU session for an XR service. The N1 SM NAS container may include the PDU session establishment request message. Thus, the XR dedicated S-NSSAI and DNN to be used for the PDU session may be known to the AMF. The PDU session establishment request message may include information about the application providing the XR service, application ID or AF ID and the AF specific SF group ID obtained by UE1 in step 701. The AF specific SF group ID may be included even outside the N1 SM NAS container. The AF specific SF group ID may identify a group of a plurality of XR service flows (or XR devices) for the XR service of UE1.

Therefore, in step 704 of FIG. 7A, the AMF receiving the NAS message (i.e., PDU session establishment request message) may send a request to the NSSF and/or NRF based on the XR dedicated S-NSSAI and DNN ID received from UE1 or previously allocated NSI ID and select an SMF appropriate for the XR service of UE1. For example, the AMF may transfer information, such as the XR dedicated S-NSSAI and UE1′s TAI information, to the NSSF and receive information about the NRF present in the network slice instance appropriate for the XR service of UE1 from the NSSF or receive the NSI ID and, based on the information received from the NSSF, transfer the XR dedicated S-NSSAI and DNN and NSI ID to the NRF, and in reply, receive an SMF instance appropriate for the XR service from the NRF and select it.

In step 705 of FIG. 7A, the AMF transfers the PDU session establishment request message received from UE1 to the selected SMF. In step 706 of FIG. 7A, the SMF, receiving the PDU session establishment request message, transmits, to the PCF, an Npcf_SMPolicyControl_Create request message including, e.g., the application ID or AF ID, AF specific SF group ID, and AF specific GPSI, as well as the SUPI, DNN, S-NSSAI, and PDU session ID, through an SM policy association establishment process. Thus, the SMF sends a request for the XR service-related information to be applied to the AF specific SF group, which is information about the service flows where the multi-modality service is to be provided in the XR service. The PCF identifies whether it has XR service-related information to be applied to UE1. If the PCF has the XR service-related information, the PCF provides it to SMF1. If not, the PCF requests and receives, from the UDR, the XR service-related information to be applied to the AF specific SF group used for the application ID or AF ID and transfers the received XR service-related information to the SMF through an Npcf_SMPolicyControl_Create response message.

In step 707 of FIG. 7A, the SMF, receiving the XR service-related information and the XR service flow detection information, newly selects a UPF if no UPF is allocated for the DNN, S-NSSAI and application ID and AF specific SF group ID, detects the ID of the QoS flow to be applied to the PDU session requested to be established for UE1 in step 708 of FIG. 7B and transfers information to be applied to the corresponding QoS flow to the UPF through N4 session establishment or update. Therefore, the information transferred to the UPF may include, e.g., QFI for the XR service flow and information for detecting the same, e.g., AF ID or application ID or AF/AS address information, i.e., IP address and port information or application level packet information, i.e., ADU ID or SN and may include information, such as the indicator indicating whether to apply the multi-modality service to the XR service flow and the delay time difference allowed when the multi-modality service is applied.

Thereafter, in step 709 of FIG. 7B, the SMF may include, in the N2 SM message container to the NG-RAN, the QFI and AF ID or application ID and AF specific SF group ID and the information about the QFIs serving the XR service flow belonging to the AF specific SF group, the indicator indicating whether dedicated queuing is required, the indicator indicating whether to apply a multi-modality service to the XR service flow, and the delay time difference allowed when the multi-modality service is applied, as SM policy information, and transfer it to the NG-RAN.

In step 711 of FIG. 7B, the UPF allocates a dedicated queue to the dedicated QFI according to the N4 session message received by the UPF in step 708, schedules for the QoS flows so that the delay time difference required to forward or schedule the respective data packets of the XR dedicated QFIs is smaller than an allowed delay time difference. In step 710 of FIG. 7B, the NG-RAN allocates a dedicated queue to the dedicated QFI according to the N2 SM message received by the NG-RAN in step 709 and schedules for the QoS flows so that the delay time difference required to forward or schedule the respective data packets of the XR dedicated QFIs is smaller than the allowed delay time difference. Accordingly, the XR devices of UE1 receiving the XR data receive XR data within the allowed delay time difference, smoothly supporting the multi-modality service to the user.

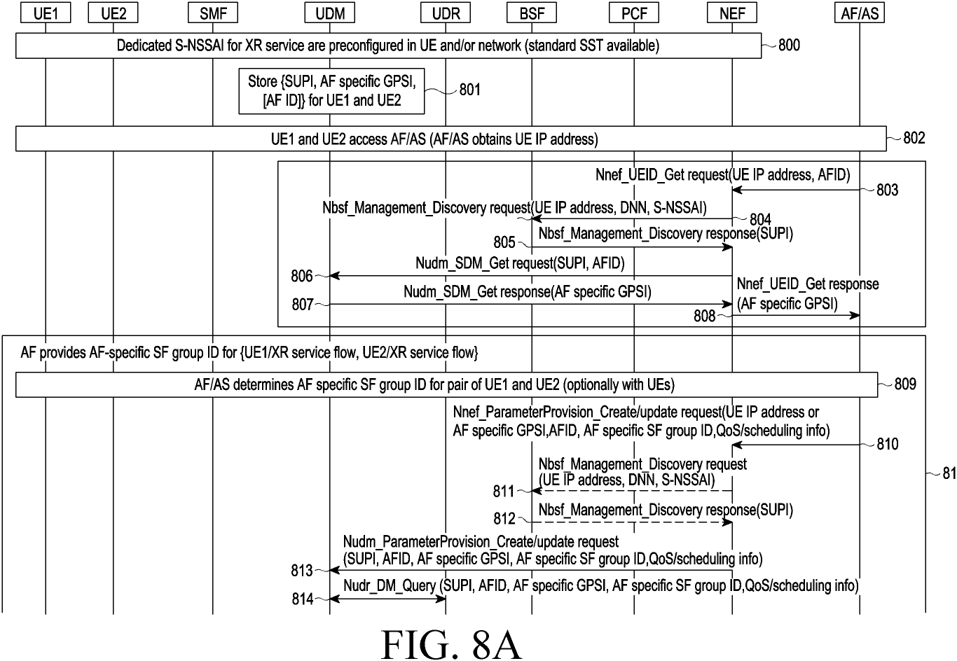

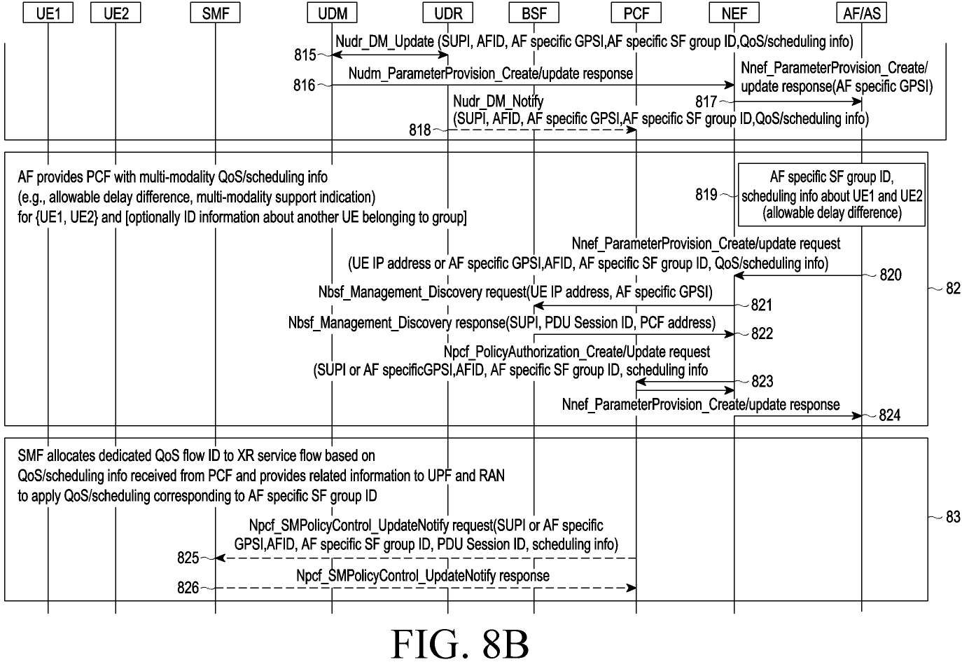

FIGS. 8A and 8B illustrate a method for forming a group of UEs (or service flows) for multi-modality support for an XR service in a wireless communication system and applying QoS information for multi-modality to the corresponding group to a 5G system according to an embodiment.

Referring to FIGS. 8A and 8B, a case where the same user uses an XR service through UE1 and UE2 is considered. UE1 and UE2 each may include an XR device or may be UEs connected with an XR device. The method of FIGS. 8A and 8B may be applied in the same manner even when a plurality of XR devices are connected to one UE, as in FIG. 1B. In this case, a group for supporting multi-modality may be a group of the plurality of XR devices (or service flows).

For an XR service, in step 800 of FIG. 8A, basic settings may be made between UE1 and UE2 and the 5G system to use the XR service. Step 800 may be performed in the same manner as step 400 of FIG. 4A. For example, it is assumed that an XR-dedicated S-NSSAI for the XR service is configured in the UEs UE1 and UE2 and/or network. The XR-dedicated S-NSSAI may include an SST for XR service as described above, or an SST for XR service provided by the communication carrier. The XR dedicated S-NSSAI may include an SD for identifying a specific XR service or a specific XR service application.

In step 801 of FIG. 8A, the subscription information about UE1 and UE2 may include the XR dedicated S-NSSAI corresponding to the XR service to be received through the network by UE1 and UE2 and may include the application ID or AF/AS ID which is the ID of the AF/AS providing the XR service to be provided to UE1 and UE2 and the AF specific GPSI or GPSI which is the ID for defining UE1 and UE2 by the AF/AS. Further, when a group of UE1 and UE2 that are to together provide the XR service is predetermined, the AF specific SF group ID for defining the group or user ID or pairing information may be included in the subscription information. As such, when the subscription information includes the AF specific SF group ID, the procedure for configuring the AF specific SF group between the AF/AS, UE1 and UE2, and the procedure for providing the 5G system with the AF specific SF group ID, which is information about the configured group, or user ID or pairing information may be omitted and, as necessary, the group information may be updated.

In step 802 of FIG. 8A, UE1 and UE2 for receiving the XR service may access the AF/AS providing the XR service and, in this case, UE1 and UE2 may access the AF/AS through the 5G system or Wi-Fi. Various communication schemes may be used for UE1 and UE2 to access the AF/AS. The AF/AS may obtain UE IP addresses of UE1 and UE2 and obtain ID information about UE1 and UE2, e.g., the AF specific GPSI or GPSI information, from the UE IP addresses from the 5G system through steps 803 to 808, as described below. However, when the AF/AS already has AF specific GPSI or GPSI information about UE1 and UE2, steps 803 to 808 may be omitted.

In step 803 of FIG. 8A, the AF/AS includes the AF ID and UE IP address in the Nnef_UEID_Get request message and send it to the NEF to obtain the ID information about UE1 and UE2, i.e., the AF specific GPSI or GPSI from the obtained IP addresses of UE1 and UE2. In step 804 of FIG. 8A, the NEF sends an Nbsf_Management_Discovery request message including the IP addresses of UE1 and UE2 along with information, and the DNN and S-NSSAI allocated for the AF/AS ID to the BSF to thereby request the SUPIs of UE1 and UE2. In step 805 of FIG. 8A, the BSF finds the SUPIs of UE1 and UE2 and responds the NEF. In step 806 of FIG. 8A, if the NEF sends an Nudm_SDM_Get request message including the SUPIs of UE1 and UE2, and the AF ID or application ID to the UDM, the UDM sends a response including the AF specific GPSIs which are the IDs of UE1 and UE2 allocated for the AF/AS and/or the application to the NEF in step 807 of FIG. 8A. In step 808 of FIG. 8A, the NEF transfers an Nnef_UEID_Get response including the AF specific GPSI for UE1 and UE2 to the AF/AS.

Meanwhile, in steps 809 to 818 of FIGS. 8A and 8B of FIGS. 8A and 8B (group 81), the AF/AS provides the AF specific SF group ID for the group of XR service flows and/or UE1 and UE2 to the 5G system. In steps 809 to 818 of FIGS. 8A and 8B, the AF/AS may allocate pairing information or user ID or AF specific SF group ID for defining a group of XR service flows and/or UE1 and UE2 together receiving an XR service, provide the allocated group information to the UDM and UDR of the 5G system, and update the group information therefrom even when there is a PCF associated with the group information.

Through the procedure of steps 809 to 818 of FIGS. 8A and 8B (group 81), the above-described XR service-related information for the multi-modality service for the AF specific SF group ID, together with the AF specific SF group ID, may be transferred to the UDM, UDR, and PCF. Alternatively, the XR service-related information for the multi-modality service for the AF specific SF group ID may be transferred to the PCF through steps 819 to 824 of FIG. 8B of FIGS. 8A and 8B (group 82), as described below.

To transfer XR data to UE1 and UE2 belonging to the AF specific SF group ID in the process of providing the AF specific SF group ID and the XR service-related information to the 5G system, the UE IDs of UE1 and UE2, e.g., the SUPI or GPSI or AF specific GPSI or UE IP addresses, may be provided together. Further, the above-described XR service flow detection information capable of detecting the XR service flow by the UPF and SMF may be provided together. The XR service flow detection information may be preconfigured in the 5G system, like the SMF or the UPF and, as described in the embodiment, be updated and applied to the SMF or UPF according to the above-described information provided through the NEF and UDR from the AF/AS, as the packet flow description (PFD).

The procedure of obtaining the IDs, e.g., AF specific GPSI or GPSI, of UE1 and UE2 from the IP addresses of UE1 and UE2 may be performed separately through the above-described operations of steps 803 to 808 of FIG. 8A or may be performed through steps 810 to 817 of FIGS. 8A and 8B, during the process of providing the AF specific group ID.

In step 809 of FIG. 8A, to indicate that UE1 and UE2 are UEs for the same user for the XR service, the AF/AS may allocate the AF specific SF group ID to UE1 and UE2 through signaling with UE1 and UE2. In this case, the AF specific SF group ID may indicate the group of UE1 and UE2 and may also indicate a group of XR service flows for XR data to be provided to UE1 and UE2. To indicate the group of UE1 and UE2 for the same user and/or the group of XR service flows of UE1 and UE2, pairing information between UE1 and UE2 or the user’s email account or the user ID managed by the application may be used instead of the AF specific SF group ID.

In step 810 of FIG. 8A, the AF/AS may transfer, to the NEF of the 5G system, an Nnef_ParameterProvision_Create request or Nnef_ParameterProvision_Update request including the XR service-related information to be applied to the AF specific SF group ID, AF ID, AF specific GPSI or UE IP addresses of UE1 and UE2 belonging to the AF specific SF group ID, providing the 5G system with information about for the multi-modality service for UE1 and UE2.

When there is no information about the UDM having the subscription information about UE1 and UE2, the NEF may obtain the IDs, i.e., SUPIs, of UE1 and UE2 for the UP IP addresses of UE1 and UE2 through the Nbsf_Management_Discovery request of steps 811 and 812 of FIG. 8A and obtain information about the UDM from the SUPI. In step 813 of FIG. 8A, the NEF includes and transfers, to the UDM, the XR service-related information to be applied to the AF specific SF group and the AF specific SF group ID, AF ID or application ID, AF specific GPSI, and SUPI through the Nudm_ParameterProvision_Create request or Nudm_ParameterProvision_Update request. Through steps 814 and 815 of FIGS. 8A and 8B, the UDM updates the UDR with the received information and, through steps 816 and 817 of FIG. 8B, sends a response to each of the NEF and/or the AF/AS. In step 817 of FIG. 8B, the AF/AS, receiving the AF specific GPSIs or GPSIs which are the IDs of UE1 and UE2 for the IP addresses of UE1 and UE2, may obtain the IDs, e.g., AF specific GPSIs or GPSIs, of UE1 and UE2.

Through the above-described procedure of group 81, the UDR may store, for the XR application defined with the application ID or AF/AS ID providing the XR service, XR service-related information to be applied to UE1 and UE2 belonging to the AF specific SF group defined with the AF specific SF group ID denoting the service flows and UE1 and UE2 together used for the XR service and information about UE1 and UE2, SUPI, and AF specific GPSI.

Through the above-described procedure of group 81, as the context for UE1 and UE2 is updated, the UDR may provide the updated XR service-related information including the AF specific SF group ID to the PCF serving the corresponding XR service flow through the Nudr_DM_Notify message.

Meanwhile, as another embodiment in which the AF/AS provides the 5G system with the AF specific SF group ID for the group of XR service flows and/or UE1 and UE2, in step 810 of FIG. 8A, the NEF for the multi-modality service for UE1 and UE2, receiving the message including the XR service-related information to be applied for the AF specific SF group and AF specific SF group ID, AF ID, AF specific GPSI, or UE IP address from the AF/AS, may directly include the XR service-related information to be applied for the AF specific SF group and AF specific SF group ID, application ID, AF ID, AF specific GPSI, and SUPI in the Nudr_DM_Create request or Nudr_DM_Update request in the UDR to transfer information for the multi-modality service instead of steps 811 to 816 of FIGS. 8A and 8B. The UDR may store the received information and then send a response message to the NEF, and the NEF may send a response message to the AF to provide the AF specific SF group ID to the 5G system. In this case, the above-described XR service-related information and the XR service flow detection information may together be provided.

Meanwhile, the procedure of group 82 in FIG. 8B is another procedure in which the AF/AS provides the AF specific SF group ID for the group of XR service flows and/or UE1 and UE2 to the 5G system. Through steps 819 to 824 of FIG. 8B, the AF/AS may separately provide the 5G system with XR service-related information to be applied to the AF specific SF group and AF specific SF group ID for the XR service flows for the AF specific SF group and transfer the XR service-related information to the PCF, so that the 5G system may perform QoS and scheduling on the XR service flow. The XR service flow detection information as well as the XR service-related information may be provided to the 5G system. The XR service flow detection information may further include protocol information indicating the XR service flow. The XR service flow detection information, as the PFD, may be received by the SMF through the NEF, and the SMF may transfer it to the UPF to be used to detect the XR service flow by the UPF. Further, as described above, the XR service flow detection information may include at least one of the ID of AF/AS, source IP address and port information, ID of application data unit (APU) which is application level packet information, or SN.

The XR service flow detection information may be preconfigured in the 5G system, like the SMF or the UPF and, as described in the embodiment, be updated and applied to the SMF or UPF according to the above-described information provided through the NEF and UDR from the AF/AS, as the PFD.

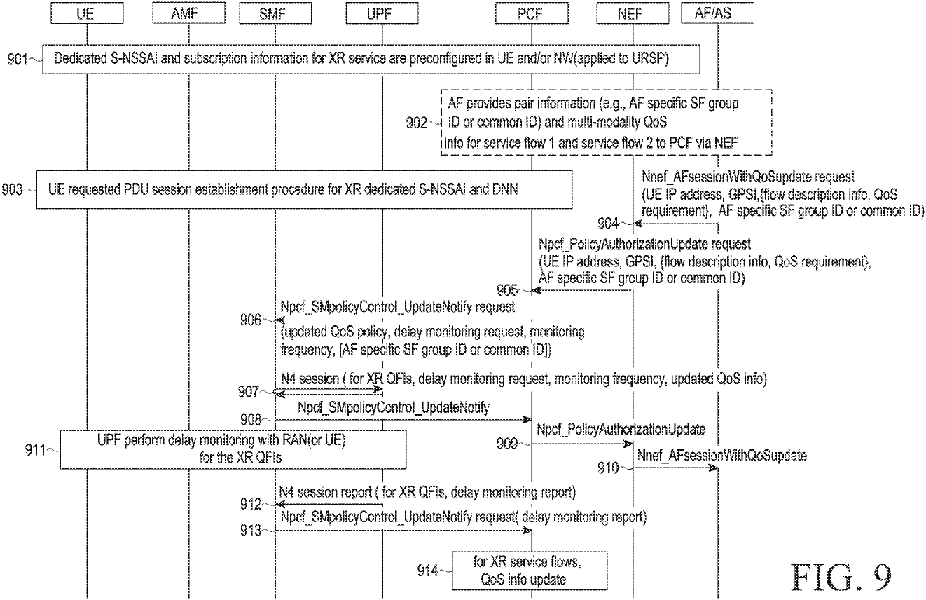

In steps 819 and 820 of FIG. 8B, the AF/AS may transfer, to the NEF of the 5G system, an Nnef_ParameterProvision_Create request or Nnef_ParameterProvision_Update request including the XR service-related information to be applied to the AF specific SF group and AF specific SF group ID, AF ID, AF specific GPSI, or UE IP address for the XR service flows and UE1 and UE2 belonging to the AF specific SF group ID to provide the 5G system with information for the multi-modality service for UE1 and UE2. In step 820 of FIG. 8B, the Nnef_ParameterProvision_Create request or Nnef_ParameterProvision_Update request message may be understood as a message for the same operation as the message transmitted from the AF/AS in step 904 of FIG. 9, as described below.

In steps 821 and 822 of FIG. 8B, the NEF may obtain address information or ID of the PCF and the PDU session ID and the SUPIs of UE1 and UE2 corresponding to the AF specific GPSI or UE IP addresses of UE1 and UE2 through an Nbsf_Managment_Discovery process, from the BSF providing the SUPI. The NEF may provide the XR service-related information to be applied to the AF specific SF group and AF specific SF group ID, AF ID, AF specific GPSI, or SUPI for the PDU session ID through the Npcf_PolicyAuthorization_Create request or Npcf_PolicyAuthorization_Update request message of step 823 of FIG. 8B.

The procedure of group 83 in steps 825 and 826 of FIG. 8B is a procedure in which the PCF provides the SMF with XR service-related information for the group of XR service flows and/or UE1 and UE2. As described above, the XR service-related information may include at least one of the XR service-related QoS information, scheduling information, and policy information to be applied to the XR service flow(s) identified by the AF specific SF group ID.

In step 825 of FIG. 8B, the PCF may transfer, to the SMF, the XR service-related information to be applied to the AF specific SF group and AF specific SF group ID, and AF ID updated based on the XR service-related information, through the Npcf_SMPolicyControl_UpdateNotify request message to apply the XR service-related information for multi-modality to the UPF and NG-RAN. In other words, the XR service-related information transferred to the SMF by the PCF may be information updated based on the XR service-related information received by the PCF from the AF/AS through the NEF.

In step 826 of FIG. 8B, the SMF, receiving the Npcf_SMPolicyControl_UpdateNotify request message, may send a response message to the PCF.

FIG. 9 illustrates a method for transferring XR data for an XR service in a wireless communication system according to an embodiment.

FIG. 9 provides an example regarding a method for applying multi-modality QoS upon receiving an XR service through one UE. Here, the UE may include a plurality of XR devices for use of an XR service or a plurality of XR devices may be wirelessly or wiredly connected to the UE.

In the method of FIG. 9 regarding transferring, to the 5G system, the above-described XR service-related information for multi-modality service for service flows for the XR service through one UE to monitor whether the multi-modality service may be changed, as necessary, to support the scheduling policy.

First, in step 901 of FIG. 9, the configuration for use of an XR service, the configuration of AF specific SF group ID or common ID for XR service, and operations for providing XR service-related information from the AF/AS to the 5G system are intended for providing the XR service to a plurality of XR devices included/connected to one UE. The UE may be configured to use the XR dedicated DNN and S-NSSAI to use the XR service, or it may be provided to the UE by the PCF to use the DNN and S-NSSAI for the XR application using the user equipment route selection policy (URSP). The URSP may include rules that are provided as configuration information for providing an XR service to the UE according to an embodiment, and each rule may include a pair of traffic descriptors (TD) and route selection descriptor (RSD). The UE may attempt to transmit the traffic matched to the TD (e.g., application identifier (app ID), destination IP address, or destination port number) in the PDU session corresponding to the RSD (e.g., S-NSSAI and/or DNN). If there is a PDU session corresponding to the RSD, the UE may attempt to transmit traffic in the PDU session and, otherwise, request to create a PDU session corresponding to the RSD.

To indicate to the PCF that a plurality of service flows (service flow1 and service flow2) of one UE are service flows supporting multi-modality service along with each service flow, the AF specific service flow group ID or common ID may be configured in the PCF of the 5G system in step 902 of FIG. 9. Alternatively as in the embodiment of FIG. 8, the AF may transfer the above-described XR service-related information for multi-modality service, along with the AF specific SF group ID or common ID, to the PCF by provisioning in the 5G system.

In step 903 of FIG. 9, the UE to receive an XR service may perform a PDU session establishment procedure on the XR dedicated S-NSSAI and DNN using the value set in the UE or the URSP in the process of performing a process of establishing a PDU session for an XR service. In the PDU session establishment procedure, if the PCF already has the AF specific SF group ID or common ID which is a parameter for providing multi-modality service for each service flow by the operation of step 902, the PCF may transfer policy and QoS information for multi-modality service to the SMF to request delay monitoring for the service flows corresponding to the multi-modality service and provide a monitoring frequency. The operations may be performed through an SM policy association establishment process to the PCF. An in steps 906 and 907, if the SMF sends an SM policy association establishment request to the PCF in operation 903, the PCF transfers, to the SMF, policy and QoS information for multi-modality service if there is already AF specific service flow group ID or common ID while requesting delay monitoring on service flows corresponding to the same multi-modality and provide a monitoring frequency. Accordingly, the SMF sends a request for delay monitoring for the corresponding QoS flows along with QoS information, to the UPF and provide a monitoring frequency.

Meanwhile, in steps 904 and 905 of FIG. 9, the AF may send a request for delay monitoring and QoS request information and AF specific service flow group ID or common ID, which is the parameter for providing multi-modality service for the corresponding service flows of the UE, to the PCF through the NEF to be able to support multi-modality service for each service flow for the corresponding PDU session. The request message transmitted from the AF to the NEF and the request message sent from the NEF to the PCF in steps 904 and 905 may include the UP IP address or GPSI to indicate what UE’s PDU session the information included in each request message is about. Each request message transmitted in steps 904 and 905 may include a description of the corresponding service flow for each service flow providing multi-modality service, and each request message transmitted in steps 904 and 905 may include information about the QoS requirements requested in the service flow. Each request message may include the AF specific service flow group ID or common ID to indicate that the service flows support the same multi-modality service. Further, each request message may include a delay monitoring request and a request monitoring frequency.

The PCF may perform an SM policy control update notification to the SMF in step 906 of FIG. 9 to apply the corresponding service flow according to, e.g., multi-modality service information or monitoring request or QoS request updated through step 905. For example, the Npcf_SMpolicyControl_UpdateNotify request message sent to the SMF by the PCF in step 905 may include at least one of updated QoS policy, delay monitoring request, and request monitoring frequency, and may further include AF specific service flow group ID or Common ID.

When the PCF does not provide the AF specific service flow group ID and common ID to the SMF in step 906, the SMF may perform delay monitoring on the corresponding QoS flow in step 911 of FIG. 9 because it is unaware of the relationship between QoS flows, i.e., whether it receives the same multi-modality service, although information is updated for each QoS flow and delay monitoring is requested. Upon receiving a delay monitoring report from the UPF in step 912 of FIG. 9, the SMF transfers the delay monitoring report to the PCF in step 913.

Upon determining that multi-modality service is not smoothly supported for the QoS flows corresponding to the same multi-modality service by referring to a pre-known delay difference threshold or QoS policy, the PCF, receiving the delay monitoring report for each QoS flow in step 913 of FIG. 9, may update the QoS policy for QoS flows and transfer the updated QoS policy information to the UPF/RAN through the SMF to thereby smoothly provide the multi-modality service in step 914 of FIG. 9.

Meanwhile, if the PCF provides the AF specific service flow group ID or common ID to the SMF in step 906, the SMF may be aware of the relationship between QoS flows, i.e., whether the same multi-modality service is used. Thus, as in step 912, upon receiving the delay monitoring report from the UPF, the SMF may directly update QoS information according to the QoS policy or pre-known delay difference threshold and transfer it to the UPF/RAN, instead of performing step 913, thereby smoothly providing the multi-modality service.

Meanwhile, the UPF, receiving the delay monitoring request along with the QoS information updated for the QoS flow from the SMF in step 907 of FIG. 9, may perform monitoring according to the monitoring frequency requested for the requested QoS flow as in step 911. The monitoring report transmitted to the SMF in step 912 by the UPF performing monitoring may include monitoring result information, e.g., time information, through the general packet radio service (GPRS) tunneling protocol-user plane (GTP-U). The time information may include, e.g., time information about transmitting packets through the GTP-U by the UPF or time information about arrival at the RAN of the packets, or time information about transfer of packets to the UE by the RAN. Alternatively, the time information may include, e.g., time information taken from transmission of a packet through the GTP-U by the UPF to the RAN or time information taken from transmission of a packet through the GTP-U by the UPF to transfer of the packet received by the RAN to the UE. The RAN or the UE may feed, back to the UPF, delay monitoring report information or delay monitoring report information measured between the RAN and the UE. Further, the UPF may collect delay monitoring information about each QoS flow through one or more pieces of information among the delay monitoring reports measured between the RAN and the UE.

Specifically, the delay monitoring report information of the RAN may include, e.g., time information about transmitting packets through the GTP-U by the UPF or time information about arrival at the RAN of the packets, or time information about transfer of packets to the UE by the RAN. Alternatively, the delay monitoring report information of the RAN may include, e.g., time information taken from transmission of a packet through the GTP-U by the UPF to the RAN or time information taken from transmission of a packet through the GTP-U by the UPF to transfer of the packet received by the RAN to the UE.

The delay monitoring report information of the UE may include time information about transmission of a packet through the GTP-U by the UPF or time information about arrival at the UE of the packet. Further, time information taken from transmission of a packet through the GTP-U by the UPF to arrival at the UE may be included.

For measurement between the base station and the UE or measurement between the UE and the UPF during delay monitoring, if the SMF receives a delay monitoring request from the PCF in step 906 of FIG. 9, the SMF may send, e.g., a PDU session modification request, to the UE through an N1 SM NAS message to prepare to perform delay monitoring between the UE and the UPF or between the UE and the RAN for the QoS flow.

Meanwhile, as shown in FIG. 9, in response to step 906, step 908 may be performed, in response to step 905, step 909 may be performed, and in response to step 904, step 910 may be performed. Steps 908, 909, and 910 may be performed in order, or steps 909 and 910 may be performed before step 908. It is not excluded that step 910 is performed before step 909. Accordingly, it should be noted that the operations of the disclosure are not limited to the order of steps shown in FIG. 9.

The above-described terms for the messages transmitted/received between the network entities in the embodiments of FIGS. 3 to 9 are examples according to the 3GPP standard and messages disclosed herein are not limited thereto.

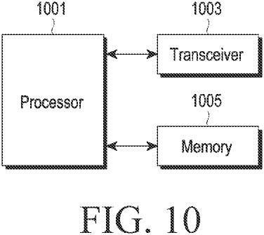

FIG. 10 illustrates a configuration of a network entity in a wireless communication system according to an embodiment.

The network entity of FIG. 10 may be one of the UE (or XR device), NG-RAN, or the NFs, such as the SMF, AMF, PCF, UDM, UDR, NSSF, NRF, NEF, and AF/AS, as described above in connection with FIGS. 1 to 9.

The network entity may include a processor 1001 that is configured to control the overall operation of the network entity according to one or a combination of two or more of the embodiments of FIGS. 1 to 9, a transceiver 1003 including a transmitter and a receiver, and a memory 1005. Without limited thereto, the network entity may include a greater number of or fewer components than those shown in FIG. 10. When the network entity of FIG. 10 is an NG-RAN, the network entity may include a transceiver for transmitting/receiving signals to/from the UE through the wireless network and a transceiver (or communication interface) for wiredly/wirelessly transmitting/receiving signals to/from the 5GC. The transceiver 1003 may transmit/receive signals to/from at least one of other network entities or a UE. The signals transmitted/received with at least one of the other network entities or the UE may include at least one of control information and data.

In FIG. 10, the processor 1001 may control the overall operation of the network entity to perform operations according to one or a combination of two or more of the embodiments of FIGS. 1 to 9 described above. The processor 1001, the transceiver 1003, and the memory 1005 are not necessarily implemented in separate modules but rather as a single chip. The processor 1001 and the transceiver 1003 may be electrically connected with each other. The processor 1001 may be an application processor (AP), a communication processor (CP), a circuit, an application-specific circuit, or at least one processor. The transceiver 1003 may include a communication interface for wiredly/wirelessly transmitting/receiving signals to/from another network entity.

The memory 1005 may store a default program for operating the network entity, application programs, and data, such as configuration information. The memory 1005 provides the stored data according to a request of the processor 1001. The memory 1005 may include a storage medium, such as ROM, RAM, hard disk, CD-ROM, and DVD, or a combination of storage media. A plurality of memories 1005 may be provided. The processor 1001 may perform at least one of the above-described embodiments based on a program for performing operations according to at least one of the above-described embodiments stored in the memory 1005.

The programs may be stored in attachable storage devices that may be accessed via a communication network, such as the Internet, Intranet, local area network (LAN), wide area network (WLAN), or storage area network (SAN) or a communication network configured of a combination thereof. The storage device may connect to the device that performs embodiments of the disclosure via an external port. A separate storage device over the communication network may be connected to the device that performs embodiments of the disclosure.

It should be noted that the above-described configuration views, example views of control/data signal transmission methods, example views of operational procedures, and configuration views are not intended as limiting the scope of the disclosure. In other words, all the components, network entities, or operational steps described in connection with the embodiments should not be construed as essential components to practice the disclosure, and the disclosure may be rather implemented with only some of the components without departing from the gist of the disclosure. The embodiments may be practiced in combination, as necessary. For example, some of the methods proposed herein may be combined to operate the network entity and the terminal.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms a, an, and the are intended to include the plural forms as well, unless the context clearly indicates otherwise.

While the disclosure has been particularly shown and described with reference to certain embodiments thereof, it will be understood by those of ordinary skill in the art that various changes in form and details may be made therein without departing from the spirit and scope of the disclosure as defined by the following claims and their equivalents.

What is claimed is:

1. A method performed by an application server (AS) for an extended reality (XR) service in a wireless communication system, the method comprising:
allocating, to at least one user equipment (UE), identification information for identifying the at least one UE using a same XR service or for identifying at least one service flow (SF) for transferring XR data to each of the at least one UE; and
providing XR service-related information including the identification information and information about a delay time allowable for the XR service to the wireless communication system accessed by the at least one UE.

2. The method of claim 1, wherein the XR service-related information includes at least one of quality-of-service (QoS) information, scheduling information, and policy information to be applied to the XR service.

3. The method of claim 1, wherein the identification information includes an application function (AF) specific SF group ID, and
wherein the XR service-related information includes at least one of an indicator indicating whether to support a multi-modality service for the at least one XR SF for the at least one UE belonging to the AF specific SF group ID or information about the allowable delay time required while transferring XR data of the at least one XR SF to the at least one UE.

4. The method of claim 1, further comprising:
providing XR SF detection information for detecting the at least one SF to the wireless communication system accessed by the at least one UE.

5. The method of claim 4, wherein the XR SF detection information is used to detect the at least one SF by at least one of a user plane function (UPF) and a session management function (SMF) of the wireless communication system, and
wherein the XR SF detection information includes at least one of an identifier (ID) of the AS, source Internet protocol (IP) address and port information, an ID of an application data unit (ADU) which is packet information about an application level, or a sequence number (SN).

6. An application server (AS) for an extended reality (XR) service in a wireless communication system, the AS comprising:
a transceiver; and
a processor configured to:
allocate, to at least one user equipment (UE), identification information for identifying the at least one UE using a same XR service or for identifying at least one service flow (SF) for transferring XR data to each of the at least one UE; and
provide XR service-related information including the identification information and information about a delay time allowable for the XR service to the wireless communication system accessed by the at least one UE through the transceiver.

7. The AS of claim 6, wherein the XR service-related information includes at least one of quality-of-service (QoS) information, scheduling information, and policy information to be applied to the XR service.

8. The AS of claim 6, wherein the identification information includes an application function (AF) specific SF group ID, and
wherein the XR service-related information includes at least one of an indicator indicating whether to support a multi-modality service for the at least one XR SF for the at least one UE belonging to the AF specific SF group ID or information about the allowable delay time required while transferring XR data of the at least one XR SF to the at least one UE.

9. The AS of claim 6, wherein the processor is further configured to provide XR SF detection information for detecting the at least one SF to the wireless communication system accessed by the at least one UE, through the transceiver.

10. The AS of claim 9, wherein the XR SF detection information is used to detect the at least one SF by at least one of a user plane function (UPF) and a session management function (SMF) of the wireless communication system, and
wherein the XR SF detection information includes at least one of an identifier (ID) of the AS, source Internet protocol (IP) address and port information, an ID of an application data unit (ADU) which is packet information about an application level, or a sequence number (SN).

11. A method performed by a policy control function (PCF) configured to manage policy information for an extended reality (XR) service in a wireless communication system, the method comprising:
receiving, from an application server (AS) configured to provide XR service through a network exposure function (NEF), a first message including identification information, the identification information for identifying at least one user equipment (UE) using a same XR service or identifying at least one service flow (SF) for transferring XR data to each of the at least one UE, and first XR service-related information including quality-of-service (QoS) information related to at least one SF based on the identification information; and
transmitting a second message including second XR service-related information, which is based on the first XR service-related information, and the identification information to a session management function (SMF) configured to manage a protocol data unit (PDU) session related to the XR service.

12. The method of claim 11, wherein the first message further includes XR SF detection information for detecting the at least one SF, and
wherein the XR SF detection information includes at least one of an identifier (ID) of the AS, source Internet protocol (IP) address and port information, an ID of an application data unit (ADU) which is packet information about an application level, or a sequence number (SN).

13. The method of claim 11, further comprising:
updating XR service-related information to be applied to the at least one SF or the at least one UE based on the received XR service-related information.

14. The method of claim 11, wherein the second XR service-related information is information updated by the PCF based on the first XR service-related information, and
wherein the first XR service-related information and the second XR service-related information each include at least one of the QoS information, scheduling information, and policy information to be applied to the at least one SF.

15. The method of claim 11, wherein the first message includes at least one of monitoring frequency information and information for requesting delay monitoring for a multi-modality service for the at least one SF.

16. A policy control function (PCF) configured to manage policy information in a wireless communication system, comprising:
a transceiver; and
a processor configured to:
receive, through the transceiver from an application server (AS) providing the XR service through a network exposure function (NEF), a first message including identification information for identifying at least one user equipment (UE) using a same XR service or identifying at least one service flow (SF) for transferring XR data to each of the at least one UE and first XR service-related information including quality-of-service (QoS) information related to at least one SF based on the identification information, and
transmit, through the transceiver, a second message including second XR service-related information, which is based on the first XR service-related information, and the identification information to a session management function (SMF) configured to manage a protocol data unit (PDU) session related to the XR service.

17. The PCF of claim 16, wherein the first message further includes XR SF detection information for detecting the at least one SF, and
wherein the XR SF detection information includes at least one of an identifier (ID) of the AS, source Internet protocol (IP) address and port information, an ID of an application data unit (ADU) which is packet information about an application level, or a sequence number (SN).

18. The PCF of claim 16, wherein the processor is further configured to update XR service-related information to be applied to the at least one SF or the at least one UE based on the received XR service-related information.

19. The PCF of claim 16, wherein the second XR service-related information is information updated by the PCF based on the first XR service-related information, and
wherein the first XR service-related information and the second XR service-related information each include at least one of the QoS information, scheduling information, and policy information to be applied to the at least one SF.

20. The PCF of claim 16, wherein the first message includes at least one of monitoring frequency information and information for requesting delay monitoring for a multi-modality service for the at least one SF.
